SEQUENCE LISTING (12 sequences)

SEQ ID NO: 1 - DNA, 20 bp, Artificial
  primer
cccaagaggcaagcagttag

SEQ ID NO: 2 - DNA, 20 bp, Artificial
  primer
ggaagtcttggaggttgctg

SEQ ID NO: 3 - DNA, 20 bp, Artificial
  primer
ttgtttccttccctggcata

SEQ ID NO: 4 - DNA, 20 bp, Artificial
  primer
tgctgtttttgctgttctgg

SEQ ID NO: 5 - DNA, 20 bp, Artificial
  primer
cccaatcctccctccattta

SEQ ID NO: 6 - DNA, 20 bp, Artificial
  primer
tgagctttgcaaggatgttg

SEQ ID NO: 7 - DNA, 20 bp, Artificial
  primer
tcctggagagcagagtggat

SEQ ID NO: 8 - DNA, 20 bp, Artificial
  primer
ggggtccctggactacactt

SEQ ID NO: 9 - DNA, 596 bp, Homo sapiens
cccaagaggcaagcagttagaaaatgccactactcatccagataaagcacataaacccatgctctttttaaaatgctgttgcttccatttctttgcaagttaaatgcaaaagcaactgtttttatgctactatattcatgcaggcatttttctgatgtagctaattgttccaatgtaaatgttgtaagttgtacacatatttgttctatacaaaatttactgtgtaatttttaagatactttttgatattatttacctacattttatcagaagtctgaaaacttaagatgaacagtatgcgtattttcagcctaagtttgtataattctaccatcagtttggagaacattaacataacatttagcaaatgaaaatgctgttacttggagagctgattattgcttcccactcactcttcgggccacctgccactgccttggtgcagaaatgcgaactagaagatggcatacgcttcctggagagcagagtggatcccatgtgccagccaggcccccaaaaacttctccaaagacttttccactccgtttctaggaaacaattctactttctttctcccagcaacctccaagacttcc

SEQ ID NO: 10 - DNA, 538 bp, Homo sapiens
ttgtttccttccctggcataagtatgtattgaaagtctcaaaatcagtccttatctggaaacttttctcagacaaaaccagtagcaacaatgtataaacaggatatagatttataaaaattcaccaaaatctgaaagacgaagaaatgggccaagatccccaaggcccatttacaacatccttgcaaagctcagaaaacgaaaattcaagccaaggatccttccatccacctctaaataactccacatcctcattccaatgcatgctggttctgtgagctaaggtccctgttaagcttttgtttactcatttatgaaatggaaataataacaataataccttctttatagagttgttgtgaaggttacatggaataatccatgcaagtacctagcaaagtgctcagcaaatatcaatattcaaaaaagtattggctataattcctaaaaataaaaaggatagaataatattttagacacaactcccaaagagaaataaccacacctttctacttttctccagaacagcaaaaacagca

SEQ ID NO: 11 - DNA, 510 bp, Homo sapiens
tcctggagagcagagtggatcccatgtgccagccaggcccccaaaaacttctccaaagacttttccactccgtttctaggaaacaattctactttctttctcccagcaacctccaagacttcctagaattctttgtactgaaaagggagtatttttttcctaaacaacttatcttgatttgtaaccagtctacaatgtcatcaagcatagtaaaaagcgtctggtggcacctctatggcggctgagtcaaaggagtgagatggattcttacagcatgactaattaaggggaaaggcttcgtgaaaaggaagtgaaggcctgactcacttgatggttccttcccctggaattttatagaggaaatttaaatcagtaaacacatttgaggagtcaacataaagaatattttaccaggccccaaggggcagaagaaaggaaaccaagggaatggtcatcaagaaatacatatagtttcatccagtggttctcaaagtgtagtccagggacccc

SEQ ID NO: 12 - DNA, 560 bp, Homo sapiens
cccaatcctccctccatttaatctaccatttccaagtttgaaataaagaatccaagtgttcaaattcaaagtgaagaactggtgaaaattctgaatctgaagttattttgtaattgattcatccatttcccactacgtctttaggaaggagttaatagtgctataaaatgccccctctcaggatggaatttttgataggagcccatttgtgagcagggaaatgattaagcattacagtatttactttattgttgccctcactactgacaaatgccaaagtaatgtggcaaggacggaggaagagggtattcaatacacagcttcaacaccagtatttacgctgagaatactcaccactgcctcgtggttgtttccttccctggcataagtatgtattgaaagtctcaaaatcagtccttatctggaaacttttctcagacaaaaccagtagcaacaatgtataaacaggatatagatttataaaaattcaccaaaatctgaaagacgaagaaatgggccaagatccccaaggcccatttacaacatccttgcaaagctca

(19) United States
(12) Patent Application Publication
(10) Pub. No.: US 2010/0070452 A1
(43) Pub. Date: Mar. 18, 2010

(54) DEVICE FOR DESIGNING NUCLEIC ACID AMPLIFICATION PRIMER, PROGRAM FOR DESIGNING PRIMER AND SERVER DEVICE FOR DESIGNING PRIMER

(76) Inventor: Yusuke Nakamura, Kanagawa (JP)

Correspondence Address: Cheng Law Group, PLLC, 1100 17th Street, N.W., Suite 503, Washington, DC, 20036, US

(21) Appl. No.: 12/306,677

(22) PCT Filed: Jul. 3, 2007
(86) PCT No.: PCT/JP2007/063632

§ 371 Date: Dec. 24, 2008

(30) Foreign Application Priority Data
Jul. 4, 2006 (JP) 2006-184992

(51) Int. Cl. G06F 17/50; G06N 5/02

(52) U.S. Cl. 706/54; 703/1

(57) ABSTRACT

It is intended to provide a device for designing a nucleic acid amplification primer, a program for designing a primer and a server device for a designing primer that will not produce undesired segments of nucleic acid by binding of primers to unintended locations in a nucleic acid amplification reaction. A program for designing primer comprising performing execution of calculating and scoring complementation, for every combination selecting two sites from the plurality of sites to be amplified, between a sequence of the candidate primer for one of the two sites, and a sequence of the amplification product obtainable in the other of the two sites, thereby determining a series of primers for amplifying the plurality of sites from the plurality of the candidate primer groups.

### TECHNICAL FIELD

The present invention relates to a device for designing a nucleic acid amplification primer, a program for designing a primer and a server device for a designing primer. The present invention relates to a calculation device, a program and a server device for designing primers for use in a reaction of amplifying a necessary base sequence from nucleic acids to be analyzed.

### BACKGROUND ART

As a reaction for simultaneously amplifying two or more nucleic acids, multiplex PCR (Polymerase Chain Reaction) is known. As a technique for conducting typing of single nucleotide polymorphisms (SNP) by utilizing multiplex PCR, for example, a “single nucleotide polymorphisms typing method” as disclosed in Patent document: Japanese Patent Application Laid-Open Publication No. 2002-300894 is known. As is disclosed in the same art, multiplex PCR is a technique that is useful for amplifying a small amount of DNA extracted from a minute amount of blood with high efficiency, and typing a great number of SNPs.

Designing of primers for use in multiplex PCR is carried out, for example, in the following manner.

First, a candidate primer corresponding to an amplification site (target) from a base sequence of DNA to be amplified is selected. As a method of selecting candidate primers from a base sequence of DNA to be amplified, for example, “Computer software program for designing optimum candidate oligo nucleic acid sequence from a nucleic acid base sequence to be analyzed utilizing computer, and a method thereof” disclosed in Patent document: Japanese Patent Application Laid-Open Publication No. 2003-99438 may be exemplified. In the following, one example of a technique of selecting a candidate primer from a base sequence of DNA to be amplified will be explained with reference to FIG. 1.

A candidate primer corresponding to a first amplification site (target) X₁ is selected from a base sequence of DNA to be amplified.

At this time, the candidate primer is selected based on a melting temperature Tm of a primer, a GC content, a length of a base sequence, specificity of a base sequence, and a score indicating unlikelihood of formation of a hairpin structure and a primer dimer.

From n candidate primers corresponding to the target X₁ wherein a Tm, a GC content, and a length of a base sequence fall within predetermined ranges, the candidate having the highest score indicating priority of the candidate primer calculated from specificity of a base sequence and unlikelihood of formation of hairpin structure and primer dimer is referred to as P₁₁, the candidate having the second highest score is referred to as P₁₂, and the candidate having the n-th highest score is referred to as P₁ₙ.

Also n′ candidate primers P₂₁, P₂₂, . . . , P_{2n′}, corresponding to the second target X₂ are selected in the same manner as described above.

Similar operations are repeated for every target, to select k candidate primers Pₘ₁, Pₘ₂, . . . , Pₘₖ corresponding to the m-th target Xₘ.

Then, in order to chose an optimum primer combination from the selected candidate primers, whether primers of different targets have complementary base sequences in unintended sites is examined. As a document that describes examining complementation between primers, Non-patent document: Rachlin J, Ding C, Cantor C. Kasif S.; Computational tradeoffs in multiplex PCR assay design for SNP genotyping; BMC Genomics; 2005 Jul. 25; 6:102 may be recited.

On the other hand, Non-patent document: Promega Corporation, Performer: Douglas R. Storts, Ph.D.), “Quantitative multiplex amplification by Plexor™ qPCR and qRT-PCR System” in the 20th International Biochemistry and Molecular Biology Conference Bio Industry Seminar (Jun. 23, 2006) discloses preliminarily eliminating mispriming to other amplicon in designing primers, however, it lacks disclosure of concrete algorism thereof.

Patent document 1: Japanese Patent Application Laid-Open Publication No. 2002-300894

Patent document 2: Japanese Patent Application Laid-Open Publication No. 2003-99438

Non-patent document 1: Rachlin J, Ding C, Cantor C, and Kasif S., “Computational tradeoffs in multiplex PCR assay design for SNP genotyping), “BMC Genomics”, Jul. 25, 2005, Vol. 6, p. 102

Non-patent document 2: Promega Corporation, Performer: Douglas R. Storts, Ph.D.), in the 20th International Biochemistry and Molecular Biology Conference Bio Industry Seminar “Quantitative multiplex amplification by Plexor™ qPCR and qRT-PCR System”, Jun. 23, 2006.

### DISCLOSURE OF THE INVENTION

### Object of the Invention

Complementation between primers may be examined in the following manner.

A primer is made up of a set of two nucleic acids having different base sequences, and for example, primer Pₓ is represented by two nucleic acids p_{xF} (Forward) and p_{xR} (Reverse). When Function pa(i, j) is expressed as a function for determining complementation between base sequences i and j, every combination of primers, that is, pa(p_{xF}, p_{yF}), pa(p_{xF}, p_{yR}), pa(P_{xR}, P_{yF}) and pa(p_{xR}, p_{xR}) should be examined for verifying complementation between primer Pₓ for target X and primer P_{y} for target Y.

Concretely, in order to examine complementation between primer P₁₁ (that is, nucleic acids p_{11F} and p_{11R}) and primer P₂₁ (that is, nucleic acids p_{21F} and p_{21R}) pa(p_{11F}, p_{21F}), pa(p_{11F}, p_{21R}) pa(p_{11R}, p_{21F}) and pa(p_{11R}, p_{21R}) are determined. On the other hand, an upper limit value paₘₐₓ of complementary score (that is, a calculated value by the above function) is defined in advance. When either of calculated values (complementary score) by the above function determined for primer P₁₁ and primer P₂₁ exceeds paₘₐₓ, it is necessary to replace P₁₁ or P₂₁ by a second candidate. Which one should be replaced may be determined based on a complementary score calculated for a combination with other primer.

First, candidates having the first priority among candidate primers selected for each target (P₁₁, P₂₁, . . . , Pₘ₁) are subjected to verification for complementation, and a complementary score is calculated for every combination of two candidates selected from the candidates of the first priority. As a result of calculation, a primer resulting in a complementary score exceeding paₘₐₓ is eliminated from the candidates. After elimination of the primer of the first priority from the candidates, a candidate primer of the second priority in the same target is subjected to verification for complementation. In this manner, a candidate primer is eliminated from the candidates in the order of higher priority.

The above operation is repeated to make the score of combination of candidate primers be paₘₐₓ or less for every target. The combination of primers determined in this manner are primers which are less likely to form a primer dimmer by the primers of different targets, and hence are primers usable in multiplex PCR.

As already described, multiplex PCR is a technique that is useful for typing a great number of SNPs. However, success and failure thereof greatly depend on design of primers used in amplification. The primers designed in conventional arts as described above sometimes failed to be amplified in an actual amplification reaction. The reason is as follows.

The conventional art as described above examines sequences of other primers in primer designing, in order to prevent a primer having a complementary sequence from being selected simultaneously, and thereby realizing an efficient amplification reaction of a target nucleic acid. In an amplification reaction, however, as the reaction proceeds, the number of primers decreases, and contrarily the number of nucleic acids increases. The speed is in proportional to 2 to the n-th power in an ideal condition when the number of cycles of the amplification reaction is “n”. Amplified nucleic acids that are not problematic in an initial stage of the reaction because of their small number are getting problematic as their number increases. In other words, when there is unintentionally the same base sequence as that of other primer in an amplified nucleic acid, the primer and the amplified nucleic acid bind each other to inhibit the amplification reaction.

This will be explained by way of a concrete example. Considering the case that 8 μL of 0.16 ng/μL DNA is amplified at 20 amplification sites by multiplex PCR, an amount of DNA before amplification may be determined in the following formula since a molecular weight is about 9.90×10¹¹ when a size of DNA is 3 Gbp.

(0.16×10⁻⁹)×8.0÷(9.90×10¹¹)=1.29×10⁻²¹ [mol]

On the other hand, when 0.83 μL of 20 sets of primers (total of 40 kinds) are used in a concentration of 1.25 μM are used, a total amount of primers is:

(1.25×10⁻⁶)×(0.83×10⁻⁶)=1.04×10⁻¹² [mol].

At this point of time, since the DNA amount is overwhelmingly smaller than the primer amount, there is no need to consider the risk that the primers bind to DNA at unintended positions, but the risk that the primers mutually bind at unintended positions is overwhelmingly large.

Next, when a total of 50 ng of 200 bp of 20 kinds of nucleic acids are produced as a result of amplification by the multiplex PCR reaction, the total number thereof is

(50×10⁻⁹)÷(6.60×10⁴)=7.58×10⁻¹³ [mol].

Herein, the calculation is made while taking a molecular mass of 200 by as 6.60×10⁴.

In this manner, as a result of multiplex PCR, the amplified nucleic acid increases to almost the same amount as the primer amount before the reaction, while on the other hand, the number of primers decreases by the number of increasing nucleic acids. As a result, the risk that primers mutually bind at unintended positions is reduced, while on the other hand, the risk that a primer and an amplified nucleic acid bind at unintended positions increases.

FIG. 2 shows an example that a primer and an amplified nucleic acid bind at an unintended position. Essentially, from primers p_{11F} and p_{21F}, x₁₁ and [x₁₁] (herein, [x₁₁] is a complementary sequence of x₁₁) would be produced as amplification products. However, since there is unintentionally a sequence that is complementary to x₁₁ in a part of primer p_{21F} for amplifying other site, p_{21F} binds in mid-course of x₁₁. As a result, other amplification products x_{11′} and [x_{11′}] (here [x₁₁′] is a complementary sequence of x₁₁′) that are shorter than intended amplifications products are produced in large amounts, so that intended amplification products x₁₁ and [x₁₁] cannot be obtained adequately.

Also the difference between the probability that two primers unintentionally have sequences that are complementary to each other, and the probability that a primer and a nucleic acid that is an amplification product unintentionally have sequences that are complementary to each other should be noticed.

For example, the probability that a sequence that is complementary to 3′-end side of sequence consisting of a bases of nucleic acid A is included in nucleic acid B having a size k [mer] is represented by the following formula:

(1/4)^{a}×(k−a+1)

The probability that two primers unintentionally have sequences that are complementary to each other, that is, the probability that a sequence that is complementary to 3′-end side sequence (suppose that a=5) of primer A is included in primer B (suppose that k=20) is determined in the following manner.

(1/4)⁵×(20−5+1)=1.6[%]

On the other hand, the probability that a primer and a nucleic acid which is an amplification product unintentionally have complementary sequences, that is, the probability that a sequence that is complementary to 3′-end side sequence (suppose that a=5) of primer A is included in amplified nucleic acid B (suppose that k=260) is determined in the following manner:

(1/4)⁵×(260−5+1)=25.0[%]

This result shows that the probability is 16 times higher than the probability that two primers unintentionally have complementary sequences to each other. Additionally, the probability increases as the size of amplification product increases.

In other words, in designing primers, if complementation between a sequence of nucleic acid amplified by a PCR reaction and a sequence of primers is not checked, the number of nucleic acids inhibiting amplification reaction will increases in later stage of the reaction. As a result, not only sufficient intended nucleic acid is not obtained, but also undesired fragments of nucleic acid are abundantly amplified due to binding of primers to unintended locations.

In view of the above, it is an object of the present invention to provide a device for designing a nucleic acid amplification primer, a program for designing a primer and a server device for a designing primer that will not produce undesired segments of nucleic acid by binding of primers to unintended locations in a nucleic acid amplification reaction.

### SUMMARY OF THE INVENTION

The inventors of the present invention found that the above object of the present invention is achieved by examining complementation between a primer for amplifying a specific site, and an amplification product produced in a site other than the specific site, and accomplished the present invention.

The present invention includes the following aspects of the invention. The present invention provides primer designing devices ([1] to [5] below)), primer designing programs ([6] to [10] below), and server devices for designing a primer ([11] to [15] below]. The followings are general explanation for the terms “candidate primer”, “candidate primer group”, “amplification product” and “amplification product group” used in [1] to [15] below.

FIG. 6 shows nucleic acid species considered for primer designing when a plurality of sites X₁, X₂, . . . , Xₘ are to be amplified in the present invention.

Candidate primers include, for example, P₁₁, P₁₂, . . . , P₁ₙ for the first amplification site X₁. Likewise, candidate primers include, for example, Pₘ₁, Pₘ₂, . . . , Pₘₖ for the m-th amplification site Xₘ.

In the present invention, the term “primer” means a pair of forward primer and reverse primer unless otherwise specified. Therefore, for example, candidate primer P₁₁ means a pair of primers, that is forward primer p_{11F} and reverse primer p_{11R}.

The term “candidate primer group” means, for example, a group consisting of a plurality of candidate primers P₁₁, P₁₂ . . . , P₁ₙ for the first amplification site X₁. Likewise, it means a group consisting of a plurality of candidate primers Pₘ₁, Pₘ₂, . . . , Pₘₖ for the m-th amplification sites Xₘ.

The term “amplification product” means, for example, each of x₁₁, [x₁₁], X₁₂, [x₁₂], . . . , x₁ₙ, and [x₁ₙ] for the first amplification site X₁. Likewise, it means each of xₘ₁, [xₘ₁], xₘ₂, [xₘ₂], . . . , xₘₖ and [xₘₖ] for the m-th amplification site Xₘ. Here, for example, [x₁₁] means a nucleic acid complementary to x₁₁, [xₘ₂] means a nucleic acid complementary to xₘ₂, and [xₘₖ] means a nucleic acid complementary to xₘₖ. The same applies to other nucleic acids.

In the present description, the wordings “amplification product producible from candidate primer” means an amplification product that is theoretically produced when amplification reaction is conducted by using the candidate primer unless otherwise specified. Therefore, for example, x₁₁ and [x₁₁] are amplification products that are theoretically produced when amplification reaction is conducted using primer P₁₁ (that is, primer pair p_{11F} and p_{11R}).

The term “amplification product group” means, for example, a group consisting of a plurality of amplification products x₁₁, [x₁₁], X₁₂, [x₁₂], . . . , x₁ₙ, and [x₁ₙ] for the first amplification site X₁. Likewise, it means a group consisting of a plurality of amplification products xₘ₁, [xₘ₁], xₘ₂, [xₘ₂], . . . , xₘₖ and [xₘₖ] for the m-th amplification site Xₘ.

The following [1] to [5] relate to primer designing devices.

[1]

A device for designing a series of primers for amplifying a plurality of sites in nucleic acid, comprising:

(I) an input unit for inputting a processing command including a calculation command A for calculating complementation between a candidate primer and an amplification product;

(II) a processing unit for performing process, upon reception of the calculation command A, including calculating and scoring complementation, for every combination selecting two sites from a plurality of sites to be amplified, between a sequence of the candidate primer for one of the two sites, and a sequence of the amplification product obtainable in the other of the two sites, thereby

determining a series of primers for amplifying the plurality of sites;

(III) a storage unit for storing at least:

data of candidate primer groups respectively made up of a plurality of the candidate primers and corresponding to each of the plurality of sites to be amplified,

data of an amplification product group made up of a plurality of the amplification products, each of the plural amplification products being obtainable by amplification reaction using the candidate primer in each of the site to be amplified,

a result of the complementation calculated by the processing unit, and

the series of primers determined by the processing unit; and

(IV) an output unit for outputting the series of primers determined by the processing unit.

That is, the above [1] is a primer designing device characterized by verifying complementation between a candidate primer and an amplification product in primer designing for amplifying a plurality of sites in nucleic acid.

[2]

The primer designing device according to [1], wherein

the processing command inputted in the input unit (I) further includes a selection command B for selecting the candidate primer group,

the process executed in the processing unit (II) further includes, upon reception of the selection command B, selecting the candidate primer group based on at least a sequence of nucleic acid to be amplified, information of sites to be amplified in the nucleic acid, and primer designing parameters, and

the storage unit (III) further stores at least the sequence of nucleic acid to be amplified, the information of sites to be amplified in the nucleic acid, and the primer designing parameters.

[3]

The primer designing device according to [2], wherein the primer designing parameters include melting temperature, GC content, base length, amplification product length, specificity of a base sequence to target site, and intermolecular complementation between primer molecules of a primer pair for one site, or intramolecular complementation of a primer molecule.

That is, the above [2] and [3] are directed, in particular, to the embodiment that the primer designing device of the present invention also performs selection of candidate primers.

[4]

The primer designing device according to any one of [1] to [3], wherein

the processing command inputted in the input unit (I) further includes a calculation command C for calculating the amplification product,

the process executed in the processing unit (II) further includes, upon reception of the calculation command C, calculating an amplification product obtainable by amplification reaction in each of the plural sites to be amplified based on at least a sequence of nucleic acid to be amplified and a sequence of the candidate primer, and the storage unit (III) further stores at least a sequence of nucleic acid to be amplified.

That is, the above [4] is directed, in particular, to the embodiment that the primer designing device of the present invention also performs calculation of an amplification product from a candidate primer.

[5]

The primer designing device according to any one of [1] to [4], wherein

the processing command inputted in the input unit (I) further includes a calculation command D for calculating complementation between the candidate primers, and

the process executed in the processing unit (II) further includes, upon reception of the calculation command D, calculating complementation, in the case two sites are arbitrarily selected from the plural sites to be amplified, between a sequence of candidate primer for one of the two sites and a sequence of candidate primer for the other of the two sites.

That is, the above [5] is directed, in particular, to the embodiment that the primer designing device of the present invention also performs verification of complementation between candidate primers.

The following [6] to [10] relate to primer designing programs.

[6]

A primer designing program for making a computer execute a process for determining a series of primers for amplifying a plurality of sequences in nucleic acid, wherein the computer is made to execute:

by provision of at least data of candidate primer groups respectively made up of a plurality of candidate primers and corresponding to each of plurality of sites to be amplified, and data of an amplification product group made up of a plurality of amplification products, each of the plural amplification products being obtainable by amplification reaction using the candidate primer in each of the site to be amplified,

upon reception of a calculation command A for calculating complementation between the candidate primer and the amplification product,

performing the step including execution of calculating and scoring complementation, for every combination selecting two sites from the plurality of sites to be amplified, between a sequence of the candidate primer for one of the two sites, and a sequence of the amplification product obtainable in the other of the two sites, thereby

performing a process for determining a series of primers for amplifying the plurality of sites from the plurality of the candidate primer groups.

That is, the above [6] is a program for designing a primer characterized by making a computer execute a process of verifying complementation between a candidate primer and an amplification product in designing primers for amplifying a plurality of sites in nucleic acid by the computer. In the present specification, the term “program” includes those directly executable by a computer, and those getting executable when installed into a hard disc or the like.

[7]

The primer designing program according to [6], further comprising performing, upon reception of a selection command B for selecting the candidate primer group, the step including execution of selecting the candidate primer group based on at least a sequence of nucleic acid to be amplified, information of sites to be amplified in the nucleic acid, and primer designing parameters.

[8]

The primer designing program according to [7], wherein the primer designing parameters include melting temperature, GC content, base length, amplification product length, specificity of a base sequence to target site, and intermolecular complementation between primer molecules of a primer pair for one site, or intramolecular complementation of a primer molecule.

That is, the above [7] and [8] are directed, in particular, to the embodiment that the primer designing program of the present invention also executes process for selecting candidate primers.

[9]

The primer designing program according to any one of [6] to [8], further performing, upon reception of a calculation command C for calculating the amplification product, a step including execution of calculating an amplification product obtainable by amplification reaction in each of the plural sites to be amplified based on at least a sequence of nucleic acid to be amplified and a sequence of the candidate primer.

That is, the above [9] is directed, in particular, to the embodiment that the primer designing program of the present invention also executes a process for calculating an amplification product from a candidate primer.

[10]

The primer designing program according to any one of [6] to [9], further performing, upon reception of a calculation command D for calculating complementation between the candidate primers, a step including execution of calculating complementation, in the case two sites are arbitrarily selected from the plural sites to be amplified, between a sequence of candidate primer for one of the two sites and a sequence of candidate primer for the other of the two sites.

That is, the above [10] is directed, in particular, to the embodiment that the primer designing program of the present invention also executes a process for verifying complementation between candidate primers.

The following [11] to [15] relate to server devices for designing a primer.

[11]

A server device for designing a series of primers for amplifying a plurality of sites in nucleic acid, capable of communicating with other computer over network, comprising:

(V) a receiving unit for receiving a processing command including a calculation command A for calculating complementation between a candidate primer and an amplification product, sent from other computer;

(VI) a processing unit for performing process, upon reception of the calculation command A, including calculating and scoring complementation, for every combination selecting two sites from a plurality of sites to be amplified, between a sequence of the candidate primer for one of the two sites, and a sequence of the amplification product obtainable in the other of the two sites, thereby

determining a series of primers for amplifying the plurality of sites from the plurality of the candidate primer groups;

(VII) a storage unit for storing:

data of candidate primer groups respectively made up of a plurality of the candidate primers and corresponding to each of the plurality of sites to be amplified,

data of an amplification product group made up of a plurality of the amplification products, each of the plural amplification products being obtainable by amplification reaction using the candidate primer in each of the site to be amplified,

a result of the complementation calculated by the processing unit, and

the series of primers determined by the processing unit; and

(VIII) a sending unit for sending the series of primers determined by the processing unit to other computer.

That is, the above [11] is a server device for designing a primer to access over network when primers for amplifying a plurality of sites in nucleic acid are designed by a computer into which the primer designing program of the present invention is not introduced, the server device being characterized by performing a process of verifying complementation between a candidate primer and an amplification product. In the present specification, the other computer over network includes a terminal device and other server device.

[12]

The server device for designing a primer according to [11], wherein

the processing command received in the receiving unit (V) further includes a selection command B for selecting the candidate primer group,

the process executed in the processing unit (VI) further includes, upon reception of the selection command B, selecting the candidate primer group based on at least a sequence of nucleic acid to be amplified, information of sites to be amplified in the nucleic acid, and primer designing parameters, and

the storage unit (VII) further stores at least the sequence of nucleic acid to be amplified, the information of sites to be amplified in the nucleic acid, and the primer designing parameters.

[13]

The server device for designing a primer according to [12], wherein the primer designing parameters include melting temperature, GC content, base length, amplification product length, specificity of a base sequence to target site, and intermolecular complementation between primer molecules of a primer pair for one site, or intramolecular complementation of a primer molecule.

That is, the above [12] and [13] are directed, in particular, to the embodiment that the server device for designing a primer of the present invention also executes process for selecting candidate primers.

[14]

The server device for designing a primer according to any one of [11] to [13], wherein

the processing command received in the receiving unit (V) further includes a calculation command C for calculating the amplification product,

the process executed in the processing unit (VI) further includes, upon reception of the calculation command C, calculating an amplification product obtainable by amplification reaction in each of the plural sites to be amplified based on at least a sequence of nucleic acid to be amplified and a sequence of the candidate primer, and

the storage unit (VII) further stores at least a sequence of nucleic acid to be amplified.

That is, the above [14] is directed, in particular, to the embodiment that the server device for designing a primer of the present invention also executes a process for calculating an amplification product from a candidate primer.

[15]

The server device for designing a primer according to any one of [11] to [14], wherein

the processing command received in the receiving unit (V) further includes a calculation command D for calculating complementation between candidate primers, and

the process executed in the processing unit (VI) further includes, upon reception of the calculation command D, calculating complementation, in the case two sites are arbitrarily selected from the plural sites to be amplified, between a sequence of candidate primer for one of the two sites and a sequence of candidate primer for the other of the two sites.

That is, the above [15] is directed, in particular, to the embodiment that the server device for designing a primer of the present invention also executes a process for verifying complementation between candidate primers.

In the above [1] to [15], in scoring of complementation for determining optimum primers from the candidate primer group, {(score of local alignment)/(length of sequence subjected to alignment)} is used as a complementation index, and it is preferred to determine that the smaller the complementation index between nucleic acids, the lower the complementation between the nucleic acids.

According to the present invention, it is possible to provide a primer designing device, a program for designing a primer, and a server device for designing a primer capable of designing suitable primers that will not produce undesired fragments of nucleic acid due to binding of primers to unintended locations in a nucleic acid amplification reaction. In primers designed by the present invention, not only complementation between primers, but also complementation between a sequence of nucleic acid obtainable by amplification reaction and a sequence of primer are taken into account, so that there is no combination having high complementation in the reaction solution. Therefore, desired amplification products can be obtained efficiently.

### BRIEF DESCRIPTION OF THE DRAWINGS

FIG. 1 is a view showing nucleic acid species considered in a conventional primer designing method.

FIG. 2 is a view explaining a problematic point occurring in a conventional primer designing method.

FIG. 3 is a view showing one example of an overall configuration of a primer designing device of the present invention.

FIG. 4 is a view showing one example of a hardware configuration when the device of FIG. 3 is implemented by using a CPU.

FIG. 5 is one example of a data arrangement view in a storage unit of a primer designing device using the primer designing program of the present invention.

FIG. 6 is a view showing a nucleic acid species considered in the primer designing method using the present invention.

FIG. 7 is a process flowchart in one example of a primer designing method using the primer designing program of the present invention.

FIG. 8 is a process flowchart in other one example of a primer designing method using the primer designing program of the present invention.

FIG. 9 is a view showing an overall configuration of a system using the server device of the present invention.

FIG. 10 is a process flowchart in one example of a primer designing method using the server device of the present invention.

FIG. 11 is a view showing nucleic acid species considered in a primer designing method in Example.

FIG. 12 is a view showing a part of information contained in a file outputted as a result of calculation of complementation between primers.

FIG. 13 is a view showing a part of information contained in a file outputted as a result of calculation of complementation between a primer and an amplification product.

FIG. 14 is a view showing a measurement result of a PCR product amount obtained as a result of PCR using primers designed in Example.

FIG. 15 is a view showing a measurement result of a PCR product amount obtained as a result of PCR using primers designed in Example.

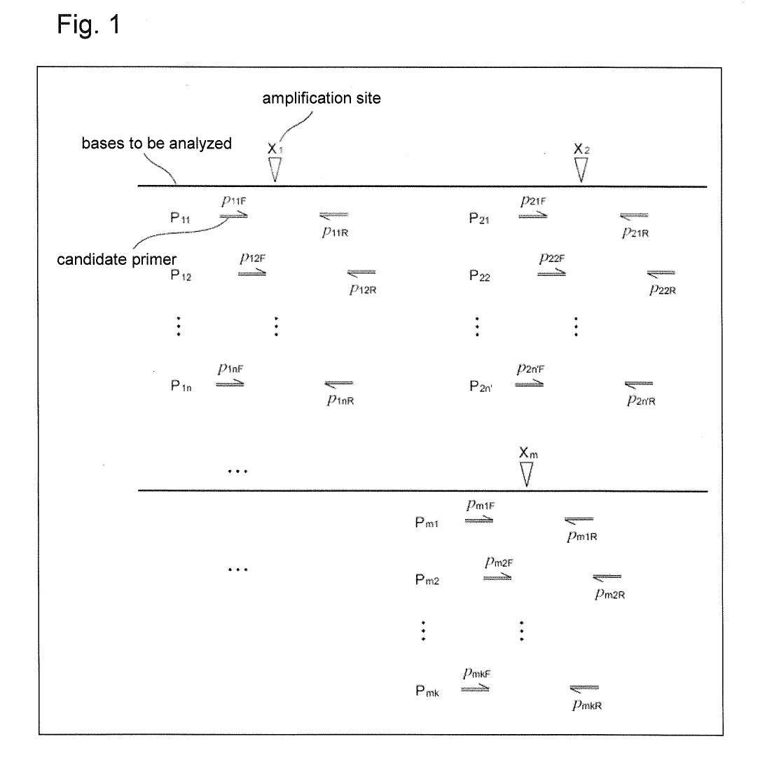

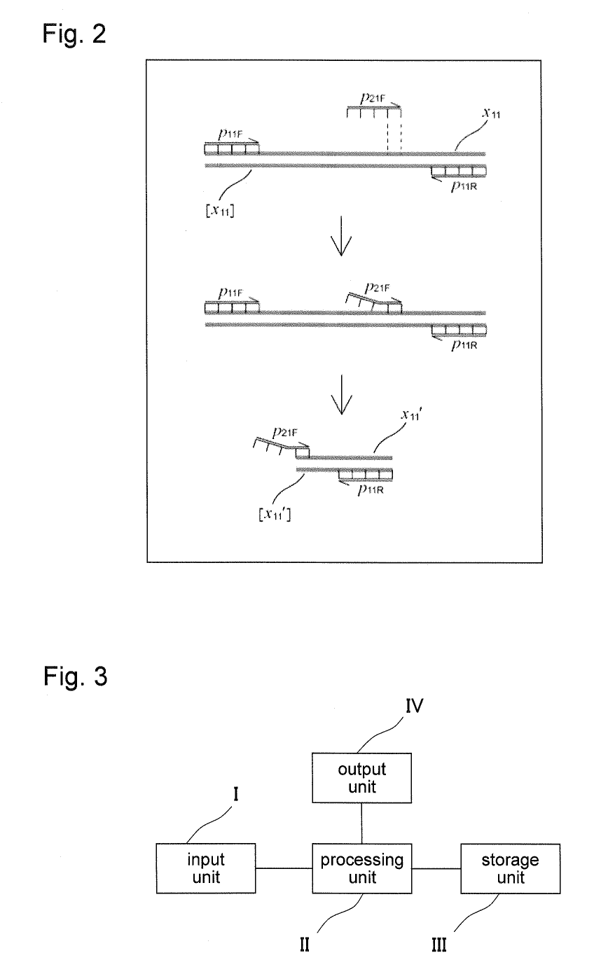

I: Input unit
II: Processing unit
III: Storage unit
IV: Output unit
1: CPU
2: RAM
3: Keyboard
4: Display
5: Hard disc
6: Program storage part
7: Data storage part
8: OS storage part
11: Amplification site information storage region
12: Combination information storage region
13: Target sequence information storage region
14: Candidate primer information storage region
15: Candidate primer number information storage region
16: Change flag information storage region
17: Complementation calculation result information storage region
18: Forward primer information and reverse primer information storage region
19: Amplification product information storage region
20: Primer-primer complementation result storage region
21: Primer-amplification product complementation result storage region
30: Server device
31, 32 and 33: Terminal device
41: Two primer sequences for which alignment calculation is to be made
42: Information indicative of 3′-end local alignment score
43: Local alignment score
44: Length of sequence subjected to alignment
45: Information indicative of location of matching base
51: Primer sequence for which alignment calculation is to be made
52: Amplification product sequence for which alignment calculation is to be made
53: Information indicative of 3′-end local alignment score
54: Local alignment score
55: Length of sequence subjected to alignment
56: Information indicative of location of matching base

### MODES FOR CARRYING OUT THE INVENTION

A primer designing device, a program for designing a primer, and a server device for designing a primer of the present invention are characterized by calculating complementation between a candidate primer and an amplification product.

### <1. Overall Configuration of Primer Designing Device>

The primer designing device of the present invention is a device for designing a series of primers for amplifying a plurality of sites in nucleic acid, and includes an input unit (I), a processing unit (II), a storage unit (III) and an output unit (IV). FIG. 3 is a block diagram showing an overall configuration of primer designing device of the present invention.

### <1-1. Input Unit>

The input unit (I) is provided for inputting a processing command and the like. Information necessary for primer designing, information of a candidate primer group, information of an amplification product group and the like may be inputted as appropriate.

More specifically, the input unit (I) is an interface for giving at least a processing command to a processing unit. As the input unit (I), a device which is an interface with a human being, such as a keyboard and a mouse, and means that forms an interface with other program or other computer, such as an interface circuit and an interface program are included.

A processing command includes at least a calculation command A for executing a process of calculating complementation between a candidate primer and an amplification product, and makes the later-described processing unit (II) execute the process. Further, the processing command may further include a selection command B for performing a process of selecting a candidate primer group, a calculation command C for performing a process of calculating an amplification product, and a calculation command D for performing a process of calculating complementation between candidate primers, and makes the later-described processing unit (II) execute these processes.

### <1-2. Processing Unit>

The details of a step of executing a processing command in the processing unit (II) will be described in <1-4. Primer designing program> below.

The processing unit (II) executes a processing command, that is, at least calculation command A, and includes CPU and the like. The processing unit (II) calculates complementation between an amplification product and a candidate primer upon reception of calculation command A.

In calculating complementation between an amplification product and a candidate primer, complementation is calculated between a sequence of a candidate primer for one site, and a sequence of an amplification product in the other site when arbitral two sites are selected from a plurality of sites to be amplified.

When also the process of selecting candidate primers is also performed by using the primer designing device of the present invention, the processing unit (II) may perform a process of selecting a plurality of candidate primers individually for each of the plurality sites to be amplified, upon reception of also the selection command B as a processing command.

When the process of determining a sequence of amplification product is also performed by the primer designing device of the present invention, the processing unit (II) may perform a process of determining a sequence of an amplification product produced by every candidate primer contained in the candidate primer group for every site to be amplified, upon reception of also the calculation command C as a processing command.

When the process of calculating complementation between candidate primers is also performed by the primer designing device of the present invention, the processing unit (II) may perform a process of calculating complementation between candidate primers of two sites when arbitrary two sites are selected from a plurality of sites to be amplified, upon reception of also the calculation command D as a processing command.

In this manner, it is possible to determine an optimum series of primers for amplification of plural sites, from the candidate primer group.

### <1-3. Storage Unit>

The storage unit (III) stores data such as data of a candidate primer group, data of an amplification product group, calculation result of complementation calculated by the processing unit (II), and data of optimum series of primers determined by the processing unit (II), and includes a main memory device such as RAM and an auxiliary memory such as hard disc.

Data and information to be stored may be read from an external database or the like, or may be obtained by the primer designing device of the present invention. When data and information to be stored is read from an external database or the like, it may be read from a removable medium such as CD-ROM via a drive, or may be downloaded from a server computer over network.

### (Data of Candidate Primer Group)

In the present invention, data of plural candidate primers is used for a specific one site to be amplified among a plurality of sites to be amplified. A plurality of different candidate primers capable of amplifying a specific one site to be amplified is herein referred to as a “candidate primer group”.

Therefore, data of a candidate primer group means data concerning plural candidate primers for each one site to be amplified. The candidate primers may be selected individually for each site to be amplified based on primer designing information including the primer designing parameters as described above.

Data of the candidate primer group includes at least information of plural candidate primers per one site to be amplified, and may further include information of a priority order of each candidate primer. Information of the candidate primer concretely includes at least sequence information of the candidate primer, and may further include positional information and size information of the candidate primer. As for the priority order of candidate primer, a higher priority order is assigned to the one that more preferably satisfies the primer designing parameters.

### (Data of Amplification Product Group)

Data of the amplification product group includes at least information of plural amplification products per one site to be amplified, and may further include information of priority order of candidate primers corresponding to the amplification products. Information of the amplification product concretely includes at least sequence information of the amplification product, and may further include a size of a sequence of the amplification product.

The term “amplification product” means an amplification product that is theoretically generated in using a candidate primer in an amplification reaction.

### (Results of Complementation)

Results of complementation may be in any form insofar as a score allowing evaluation of complementation is included. The way of scoring may be appropriately determined by the one skilled in the art, and thus is not particularly limited, and for example, a length of bases matching between sequences of nucleic acids to be compared, or an amount corresponding to the proportion of bases matching between sequences of nucleic acids to be compared may be used as a score.

In the present invention, it is particularly preferred that a ratio between a score by local alignment based on complementation (hereinafter, also referred to as a “score” in some cases) and length of sequence subjected to alignment (hereinafter, also referred to as a “length” in some cases) (hereinafter, also referred to as a “ratio” in some cases), or in other words, a value obtainable by dividing the score by the length is used as an index for evaluation of complementation (complementation index). Herein, the larger length and the smaller score indicate lower complementation. Therefore, it shows that the smaller the ratio represented as a proportion of the score relative to the length, the lower the complementation between the two subject sequences. The inventors of the present invention have found that a ratio value which is a preferred complementary score of the present invention, in particular, when it is calculated by complementation calculation between a candidate primer and an amplification product, shows good correlation with an amount of the amplification product when amplification of plural sites is actually conducted using the candidate primer, and hence the value is very reliable.

### (Data of Optimum Series of Primers)

In the processing unit (II), for each site to be amplified, complementation is evaluated at least for every combination between a candidate primer and an amplification product, and as a result, a candidate primer having the best evaluation of complementation in the candidate primer group is determined as an optimum candidate primer.

Therefore, data of the optimum series of primers is data concerning a set of candidate primers as described above determined from each and every site to be amplified, and includes at least sequence information.

### (Other Information)

The storage unit (III) may include the following information besides the data as described above.

For example, information of a sequence of nucleic acid to be amplified, and information of plural sites to be amplified may be included. Information of site to be amplified includes at least positional information of the site to be amplified, and may further include a sequence of the site to be amplified and a size of the sequence.

Further, it may include primer designing parameters, which are parameters that primers should satisfy at the minimum. Examples of the primer designing parameters include parameters representing a melting temperature, a GC content, a base length, an amplification product length, specificity of a base sequence to a target site, and intermolecular complementation between primer molecules of a primer pair for one site (that is, likelihood of forming a primer dimer) or intramolecular complementation of a primer molecule (likelihood of forming a hairpin structure). In addition, priority orders of these parameters may also be included.

Further, information of every combination selecting two sites from the sites to be amplified may be included. For two sites combined in each combination, complementation between a candidate primer for amplifying one site and an amplification product producible in other site may be calculated in the processing unit (II). Furthermore, for the two sites, complementation between a candidate primer for one site and a candidate primer for the other site may be calculated in the processing unit (II).

Furthermore, the storage unit (III) may further include information of flag for identifying a candidate primer during calculation performed in the processing unit (II), besides the above data and information.

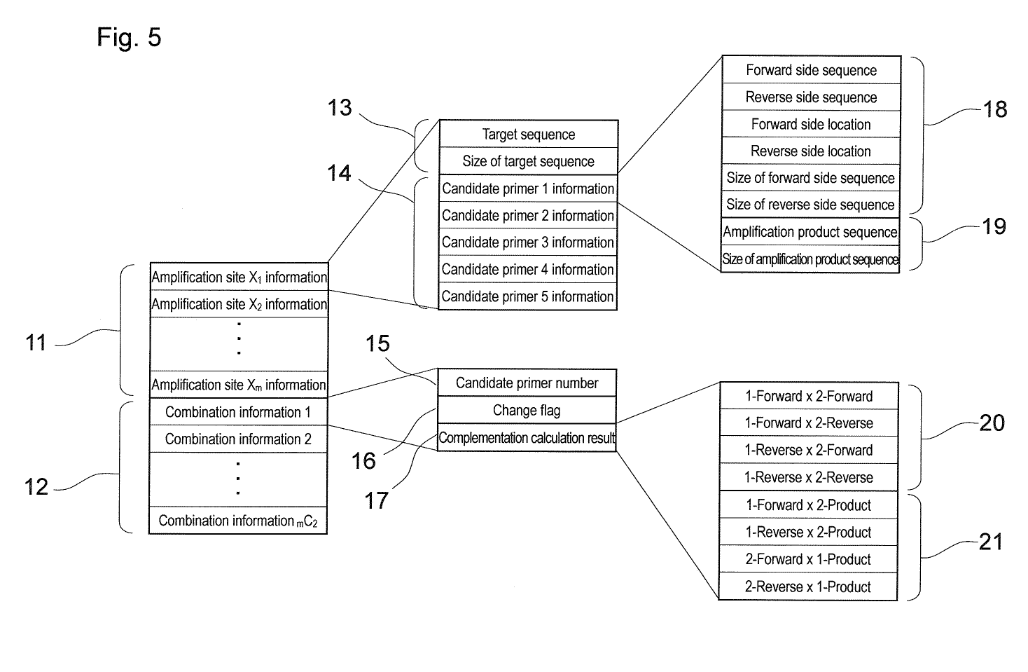

Each data and information as described above may be stored in the storage unit (III), for example, in an arrangement as shown in FIG. 5 that will be described later.

### <1-4. Output Unit>

The output unit (IV) refers to a unit for output of at least a determined optimum series of primers, and includes a display, and the like. An optimum embodiment of output of primers includes output of a primer sequence itself and output of a data file including a primer sequence. The term output is the concept including the case of providing other programs or devices in the form of data, as well as displaying and printing.

### <2. Operation Outline of Primer Designing Device>

One example of operation outline of a primer designing device of the present invention will be described below. The details of the step of executing a processing command in the processing unit (II) will be described in the later section of <1-4. Primer designing program>.

The storage unit (III) stores candidate primer group data, and amplification product group data. The candidate primer group data may contain information of priority order of each candidate primer, together with sequence information of a plurality of candidate primers. Data of an amplification product group may contain information of priority order of a candidate primer corresponding to the amplification product, together with sequence information of an amplification product.

When calculation command A is inputted as a processing command to the input unit (I), the candidate primer group data, and the amplification product group data stored in the storage unit (III) is sent to the processing unit (II), and complementation between a candidate primer and an amplification product is calculated. Calculation result of complementation is stored in the storage unit (III).

In the primer designing device of the present invention, besides the calculation of complementation between a candidate primer and an amplification product as described above, a step of selecting candidate primers, a step of determining a sequence of amplification product, and/or a step of calculating complementation between candidate primers may be performed.

When the step of selecting candidate primers is performed by the primer designing device of the present invention, upon reception of selection command B as well, as a processing command from the input unit (I), the processing unit (II) may invoke at least a sequence of nucleic acid to be amplified, information of site to be amplified in the nucleic acid, and primer designing parameters from the storage unit (III), and perform a process for selecting a plurality of candidate primers individually for each of plural sites to be amplified. The data of selected candidate primers is stored in the storage unit (III).

When the step of determining a sequence of amplification product is performed by the primer designing device of the present invention, upon reception of calculation command C as well, as a processing command from the input unit (I), the processing unit (II) may invoke at least a sequence of nucleic acid to be amplified, and a candidate primer sequence from the storage unit (III), and perform a process for calculating an amplification product. The determined data of amplification product is stored in the storage unit (III).

When the step of calculating complementation between candidate primers is performed by the primer designing device of the present invention, upon reception of calculation command D as well, as a processing command from the input unit (I), the processing unit (II) may invoke at least information of the candidate primer from the storage unit (III) and calculate complementation between candidate primers. Calculation result of complementation is stored in storage unit (III).

The processing unit (II) is able to determine primers having the highest priority order in each amplification site as an optimum series of primers, when every process for primer designing is complete including calculation of complementation between a candidate primer and an amplification product. Data of the calculated result of complementation and the determined series of primers is stored in the storage unit (III). The data of optimum series of primers stored in the storage unit (III) is outputted to the output unit (IV).

### <3. Hardware Configuration>

When the processing unit of FIG. 3 is implemented by a central processing unit CPU, the primer designing device of the present invention is implemented as a personal computer. In this case, as other configuration elements, the input unit is implemented by a keyboard, the output unit is implemented by a display, and the storage unit is implemented by a main memory device such as RAM and an auxiliary memory device such as a hard disc.

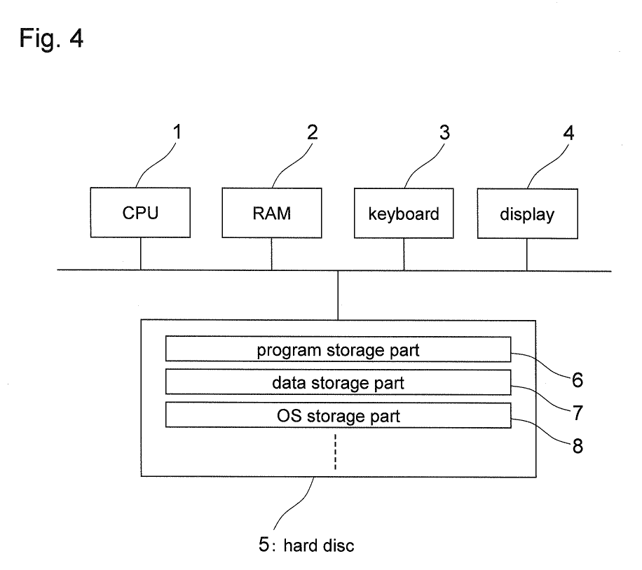

A hardware configuration of the primer designing device of the present invention is shown in FIG. 4. In FIG. 4, to a CPU 1, a RAM 2, a keyboard 3, a display 4 and a hard disc 5 are connected. The hard disc includes regions such as a primer designing program storage part 6, a data storage part 7, an operating system (OS) storage part 8, and the like, which respectively store a primer designing program, data and an OS. When the primer designing program is started, the program is loaded to the RAM 2 from the hard disc 5, and sent to the CPU 1 where processes such as calculation are performed, and the result thereof is written back to the RAM 2. These series of operations realize the function of the present invention.

Respective data and information recited in the above section of <1-3. Storage unit> is stored in the data storage part 7 in FIG. 4. More specifically, as shown in FIG. 5, for example, the data storage part may have regions 11 storing information of each of plural amplification sites, and region 12 storing information of a combination selecting two sites from these amplification sites.

Each of the regions 11 of information of amplification site may have regions 13 of information of a sequence that is to be an amplification target, and regions 14 of information of candidate primers capable of amplifying the amplification target. The regions 13 may have a region of information of a base sequence which is to be an amplification target, and a region of information of a size of the sequence which is to be an amplification target. Each of the regions 14 may have regions 18 of information of the Forward side candidate primer (hereinafter, referred to as a forward primer) and information of the Reverse side candidate primer (hereinafter, referred to as a reverse primer) and regions 19 of information of amplification product which is producible by the candidate primer.

The regions 18 may have a region of sequence information of the forward primer, a region of sequence information of the reverse primer, a region of positional information of the forward primer, a region of positional information of the reverse primer, a region of a size information of a sequence of the forward primer, and a region of size information of a sequence of the reverse primer. The regions 19 may have a region of sequence information of amplification product producible by candidate primer, and a region of size information of a sequence of the amplification product.

The regions 12 of information of combination selecting two sites from amplification sites may have a region 15 of number information of combined sites, a region 16 of information of change flag of priority order in the site, and a region 17 of calculation result of complementation in the combination.

The region 17 may have a region 21 of calculation result of complementation between a candidate primer and an amplification product in the combined sites, and an region 20 of calculation result of complementation of candidate primers in the combined regions.

### <4. Primer Designing Program>

A primer designing program which is one embodiment of the present invention is a program for making a computer perform a process of determining a series of primers for amplifying a plurality of sequences in nucleic acid. The primer designing program of the present invention is preferably used while being introduced into a device for designing a primer and a server device for designing a primer of the present invention.

By the primer designing program of the present invention, at least the process of calculating complementation between a candidate primer and an amplification product is performed. In calculating complementation between a candidate primer and an amplification product, data of candidate primer group, and data of amplification product group are supplied. The details of these information and data, and other information and data that may be supplied are as previously described in the section of <1-3. Storage unit> in the above <1. Overall configuration of primer designing device>.

Calculation of complementation between a candidate primer and an amplification product is performed upon reception of calculation command A. Specifically, upon reception of calculation command A, a process of calculating complementation between a sequence of a candidate primer corresponding to one site of two sites arbitrarily selected from a plurality of sites to be amplified, and a sequence of an amplification product obtained in other site of the two sites is performed. In calculation of complementation between a candidate primer and an amplification product, when the calculation result (that is, calculated complementary score) does not satisfy a predetermined condition of the complementary score, priority order of the candidate primer is rewritten. Calculation of complementation may be repeated while priority order of the candidate primer is rewritten so that the condition of the complementary score is satisfied in every combination of a candidate primer and an amplification product.

Prior to the process of calculating complementation between a candidate primer and an amplification product, a process of selecting a candidate primer and a process of determining an amplification product may be performed. Further, the process of calculating complementation between a candidate primer and an amplification product may be performed appropriately with other processes for verifying complementation between nucleic acid species that are present in the amplification reaction solution. For example, after performing the process step of selecting candidate primers, calculation process of complementation between a candidate primer and an amplification product, and calculation process of complementation between candidate primers may be performed. In this case, either the calculation process of complementation between a candidate primer and an amplification product or the calculation process of complementation between candidate primers may be performed at first.

The process of selecting candidate primers is performed upon reception of selection command B. Concretely, by receiving selection command B, a candidate primer group is selected based on at least nucleic acid sequences to be amplified, information of site to be amplified in the nucleic acid, and primer designing parameters.

The process of determining amplification products is performed upon reception of calculation command C. Concretely, by receiving calculation command C, an amplification product obtainable by an amplification reaction is calculated in each of the plural sites to be amplified from at least nucleic acid sequences to be amplified and sequences of candidate primers.

The process of performing calculation of complementation between candidate primers is performed upon reception of calculation command D. Concretely, by receiving calculation command D, complementation between a sequence of candidate primer for one site of two sites arbitrarily selected from a plurality of sites to be amplified, and a sequence of candidate primer for the other site of the two sites is calculated.

Primers having the highest priority order in each amplification site may be determined as an optimum series of primers, when all processes for primer designing are completed.

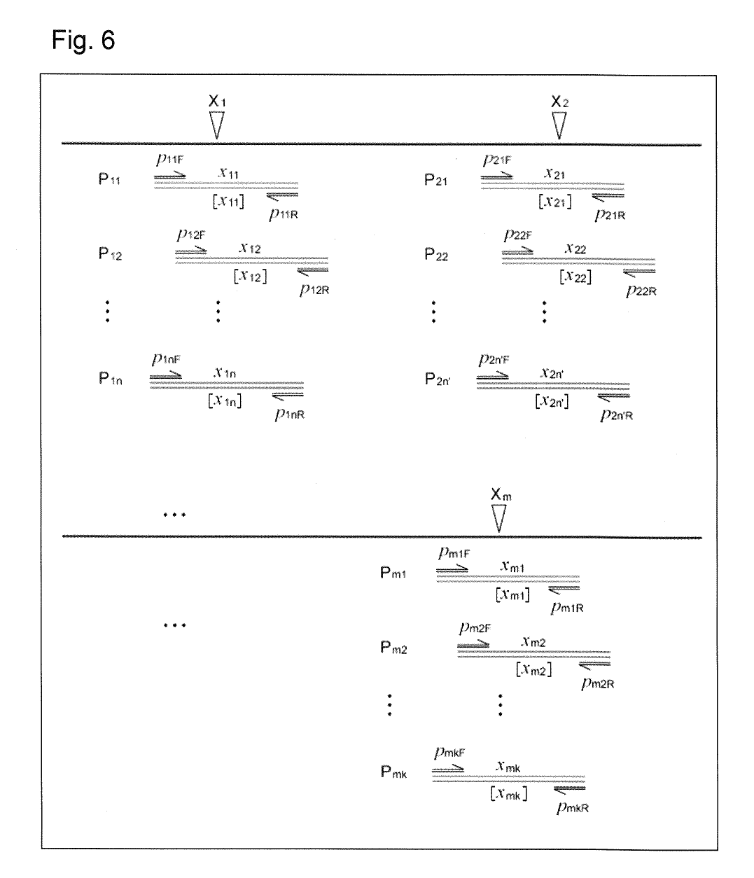

In the following, referring to FIG. 6, a program of the present invention will be explained by way of a flowchart showing an example of primer designing method using a program of the present invention.

### <4-1. Process Flowchart 1>

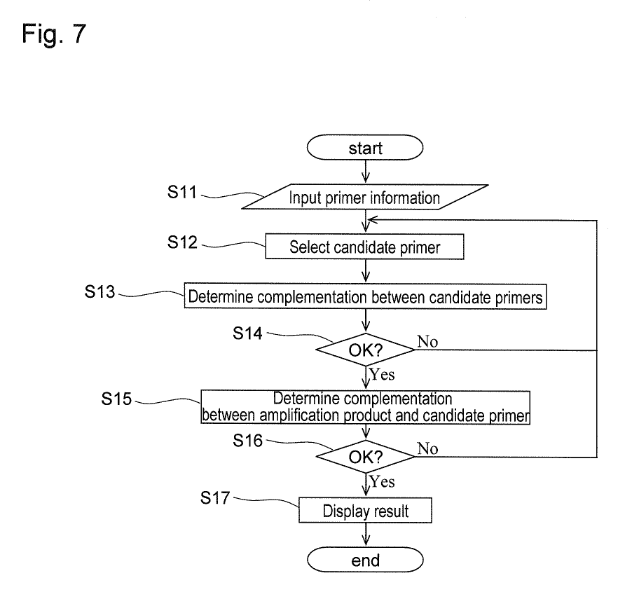

FIG. 7 is a flowchart showing one example of a primer designing method using the program of the present invention. The flowchart 1 includes an inputting step S11, a candidate primer selecting step S12, a complementation calculating step between primers S13, a complementation calculating step between a primer and an amplification product S15, and an outputting step S17.

In S11, sequences of nucleic acids to be amplified, information of sites to be amplified, and primer designing parameters are inputted. Herein, as shown in FIG. 6, it is supposed that m amplification sites (targets X₁, X₂, . . . , Xₘ) are amplified. Further, in S11, calculation command A, selection command B, calculation command C, and calculation command D are inputted.

In S12, upon reception of selection command B, candidate primers are selected individually for each of m amplification sites (targets X₁, X₂, . . . , Xₘ) from the base sequence of DNA to be amplified. Herein, it is supposed that k candidate primers for the m-th target Xₘ are referred to as Pₘ₁, Pₘ₂, . . . , Pₘₖ.

In S13 to S14, upon reception of calculation command D, whether candidate primers in different targets have complementary base sequences in unintended locations is examined.

In S15 to S16, upon reception of calculation commands C and A, whether amplification products producible by an amplification reaction using candidate primers, and the candidate primers have complementary base sequences at unintended locations is examined.

First, in S13, in every combination selecting two sites from m amplification sites X₁, X₂, . . . , Xₘ, a score indicating complementation between sequences of the first candidate primers is respectively calculated. In other words, in every combination selecting two from the first candidate primers P₁₁, P₂₁, . . . , Pₘ₁ among candidate primers of each target, a score indicating complementation of sequences is respectively calculated. The details are as described above in the background art. To be specific, for example, when complementation between candidate primers is examined in a combination selecting X₁ and X₂ from m amplification sites X₁, X₂, . . . , Xₘ, a complementary score is calculated by determining pa(p_{11F}, p_{21F}), pa(p_{11F}, p_{21R}), pa(p_{11R}, p_{21F}) and pa(p_{11R}, p_{21R}). Here, function pa(i, j) is represented as a function for determining complementation between base sequences i and j. On the other hand, a complementary score upper limit paₘₐₓ is set in advance. And whether a calculated value of complementary score exceeds the paₘₐₓ is verified. When the calculated value exceeds the upper limit, priority order is rewritten by replacing the candidate primer by the second candidate. Then, the replaced candidate is subjected to calculation of complementary score, verification, and as necessary, rewriting of priority order of candidate primer in the same manner as described above. In this manner, calculation of a complementary score and rewriting of priority order of candidate primer are repeated.

In S14, whether the condition that a calculated value of complementary score is paₘₐₓ or less is satisfied in every combination of amplification sites is determined. When the condition is satisfied (Yes), the flow proceeds to the step of S15. When the condition is not satisfied (No), the flow returns to S12. In this case, the steps of S12 to S14 are performed until the condition in S14 is satisfied by performing a method of selecting a candidate primer of lower priority order in selection of candidate primer in S12, or a method of selecting a candidate primer by changing condition of primer designing parameters, or a method of selecting a candidate primer by modifying the candidate primer selecting method itself.

S15, scores indicating complementation between a first candidate primer in one amplification site and an amplification product producible by a first candidate primer in the other amplification site is respectively calculated in every combination selecting two sites from m amplification sites X₁, X₂, . . . , Xₘ.

In S15, first, an amplification product that is producible when the selected candidate primers are used in a nucleic acid amplification reaction is calculated. The way of calculating the amplification product is not particularly limited, and may be appropriately performed by a person skilled in the art. For example, an amplification product may be determined from a sequence of nucleic acid to be amplified and positional information of site to be amplified.

Next, calculation of complementary score is performed. For example, when complementation between a candidate primer and an amplification product is examined in combination selecting X₁ and X₂ from m amplification sites X₁, X₂, . . . , Xₘ, a score indicating complementation is calculated for the next combination of nucleic acid species.

Herein, sequences of amplification products producible by a nucleic acid amplification reaction from the first candidate primer P₁₁ (forward primer P_{11F} and reverse primer p_{11R}) for target X₁ are represented by x₁₁ and [x₁₁], and sequences of amplification products producible by a nucleic acid amplification reaction from the first candidate primer P₂₁ (forward primer p_{21F} and reverse primer p_{21R}) for target X₂ are represented by x₂₁ and [x₂₁].

As to complementation between an amplification product by candidate primer P₂₁, and candidate primer P₁₁, calculation of a score indicating complementation may be achieved by calculation of pa(p_{11F}, x₂₁) Pa(p_{11F}, [x₂₁]), pa(p_{11R}, x₂₁), and pa(p_{11R}, [x₂₁]).

Further, as to complementation between amplification product by candidate primer P₁₁, and primer P₂₁, a score indicating complementation may be calculated by calculation of pa(p_{21F}, x₁₁), pa(p_{21F}, [x₁₁]), pa(p_{21R}, x₁₁), and pa(p_{21R}, [x₁₁]).

On the other hand, an upper limit pa_{max-product} of complementary score (that is, calculated value by the above function) between amplification product and candidate primer is set in advance. And whether a calculated value by the above function representing complementation between amplification product and candidate primer exceeds the upper limit pa_{max-product} is verified. When the calculated value exceeds the upper limit, priority order is rewritten by replacing the candidate primer or amplification product by the second candidate. And for the replaced candidate, calculation of complementary score, verification, and as necessary, rewriting of priority order are performed in the same manner as described above. In this manner, calculation of complementary score and rewriting of priority order are repeated.

In S16, whether the condition that the calculated value of a complementary score is pa_{max-product} or less is satisfied in every combination of amplification sites is determined. When the condition is satisfied (Yes), the flow proceeds to the step of S17. When the condition is not satisfied (No), the flow returns to S12. In this case, the steps S12 to S16 are performed until the condition in S16 is satisfied while changing the candidate primer selecting method in S12.

By the steps as described above, candidate primers wherein a score of combination between candidate primers is paₘₐₓ or less, and score of combination between candidate primer and producible nucleic acid is pa_{max-product} or less are obtained for every amplification site. Such candidate primers are determined as optimum primers, and the optimum primers are outputted in S17.

### <4-2. Process Flowchart 2>

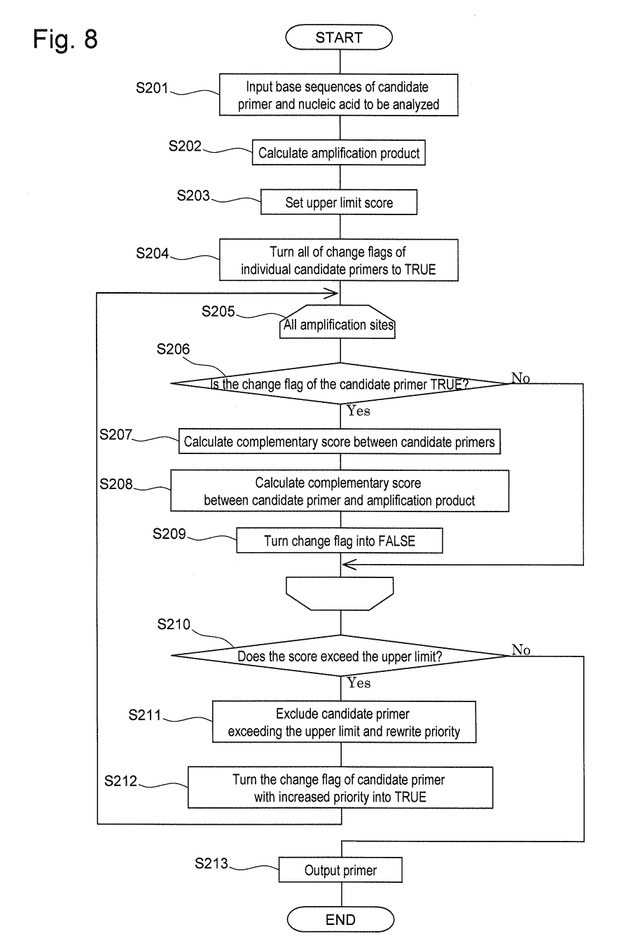

FIG. 8 is a flowchart showing the other one example of primer designing method using a program of the present invention. The other one example of flowchart is shown. The flowchart 2 includes an inputting step S201, an amplification product calculating step S202, a complementation calculating step between primers S207, a complementation calculating step between a primer and an amplification product S208, and an outputting step S213. In the following explanation for the flowchart 2, the process of determining whether the condition of complementary score is satisfied after calculation of complementation, and rewriting the priority order of primer will be explained more specifically. Other processes such as performing calculating complementation are the same as described in the example of the above flowchart 1.

In S201, sequences of nucleic acids to be amplified, information of sites to be amplified, and candidate primer data are inputted. At this time, for example, the input may be made in a file format where such information or data is written. When it is supposed that m amplification sites (targets X₁, X₂, . . . , Xₘ) are amplified, information of sites to be amplified is stored in regions 11 of amplification site X₁ information to amplification site Xₘ information as shown in the foregoing FIG. 5. The candidate primer data is stored in regions 14 of these amplification site information. Furthermore, in S201, calculation command A, calculation command C, and calculation command D are inputted.

In S202, upon reception of calculation command C, amplification product is calculated based on information of sequence of nucleic acid to be amplified and of site to be amplified. The calculated data of amplification product is stored in a region of amplification product information 19 in the region of candidate primer information 14 as shown in FIG. 5.

In S203, an upper limit value of complementary score between candidate primers, and an upper limit value of complementary score between a candidate primer and an amplification product are set. The upper limit values may be inputted by a user, however, in this example, the values may be written in advance.

In S204, all of the candidate primer change flags in respective candidate primers are set to be TRUE. The candidate primers for which the flag is TRUE will be subjected to a process of calculating complementary score between candidate primers and complementary score between a candidate primer and an amplification product after blanching in S206 as will be described latter. In the initial state, all of the flags are set to be TRUE as an initial state, in order to perform calculation for every candidate primer.

In S205, instruction is made to execute calculation of a complementary score between candidate primers and calculation between a candidate primer and an amplification product for every combination selecting two sites from the amplification sites in the following step. For example, the process of S206 to S209 is repeated for every combination in such a manner that for combination 1 stored in combination information region 12 shown in FIG. 5, the process of S206 to S209 is performed, and for combination 2, the process of S206 to S209 is performed. The calculation is performed for the one having the highest priority order among the candidate primers with TRUE flag, and amplification products producible thereby.

In S206, whether the candidate primer change flag is TRUE is determined. Here, it is supposed that, as a candidate primer change flag, TRUE is given to a candidate primer in combination of amplification site for which calculation has not been performed yet, while FALSE is given to a candidate primer in combination of amplification site for which calculation has been already performed. Flag information is stored in region of a candidate change flag 16 in region of combination information 12 as shown in FIG. 5. When the candidate primer change flag is TRUE, calculation of complementation is performed for combination of that site. When the candidate primer change flag is FALSE, the site to be calculated is shifted to the next site rather than repeating the same calculation for combination of that site.

In S207, complementary score between candidate primers is calculated. The calculation result is stored in region of calculation result of complementation between candidate primers 20, in region of complementation calculation result 17 shown in FIG. 5. For example, in a combination selecting amplification sites X₁ and X₂, calculation result of pa(p_{11F}, p_{21F}) is stored in a region of 1-Forward×2-Forward, calculation result of pa(p_{11F}, p_{21R}) is stored in a region of 1-Forward×2-Reverse, calculation result of pa(p_{11R}, p_{21F}) is stored in 1-Reverse×2-Forward, and calculation result of pa(p_{11R}, p_{21R}) is stored in 1-Reverse×2-Reverse.

In S208, complementary score between a candidate primer and an amplification product is calculated. The calculation result is stored in region of calculation result of complementation between a candidate primer and an amplification product 21, in region of complementation calculation result 17 shown in FIG. 5. For example, in a combination selecting amplification sites X₁ and X₂, calculation result between pa(p_{11R}, x₂₁) and pa(p_{11F}, [x₂₁]) is stored in 1-Forward×2-Product, calculation result between pa(p_{11R}, x₂₁) and pa(p_{11R}, [x₂₁]) is stored in 1-Reverse×2-Product, calculation result between pa(p_{21F}, x₁₁) and pa(p_{21F}, [x₁₁]) is stored in 2-Forward×1-Product, and calculation result between pa(p_{21R}, [x₁₁]) and pa(p_{21R}, [x₁₁]) is stored in 2-Reverse×1-Product.

In S209, candidate primer change flag in the combination for which calculation is finished in the above S207 and S208 is changed to FALSE.

In S210, the flow blanches depending on whether the calculated value of complementary score obtained in the above S207 or S208 exceeds the upper limit value set in the above S203, or not. When the calculated value exceeds the upper limit value, the flow proceeds to S211, and when not so, the flow proceeds to S213.

In S211, in order to eliminate the candidate primer, wherein the calculated value of complementary score obtained in the above S207 or S208 exceeds the upper limit value set in the above S203, from subjects of calculation of complementation, the candidate primer to be calculated is rewritten to a candidate primer of the next priority order.

In S212, since it is necessary to perform calculation of the above S207 and S208 again for combinations including the candidate primer whose priority order is moved up in the above S211, all flags of candidate primers in the combinations to be calculated are rewritten to TRUE. Thereafter, the flow returns again to S205.

In S213, in every combination selecting two sites from the amplification sites, a candidate primer wherein the calculation result in the above S207 and S208 satisfies the condition of not more than the upper limit value of a complementary score set in S203, and has the highest priority order may be determined as a primer for use in amplification reaction, and outputted. At this time, the output may be made, for example, in a file format in which sequence of the determined primer is written.

### <5. Primer Designing Server Device>

The server device for designing a primer of the present invention is a server device capable of communicating over network in designing primers for amplifying a plurality of sites in nucleic acid by other computers, and is characterized by performing a process of verifying complementation between a candidate primer and an amplification product. Other computer via network includes a terminal device and other server device. As network, the Internet, LAN and the like are recited. The server device of the present invention has a receiving unit (V), a sending unit (VIII) for communication, and a processing unit (VI) and a storage unit (VII) likewise the aforementioned primer designing device of the present invention, and has the same hardware configuration as the aforementioned primer designing device of the present invention except that the receiving unit (V) and the sending unit (VIII) are provided (not shown).

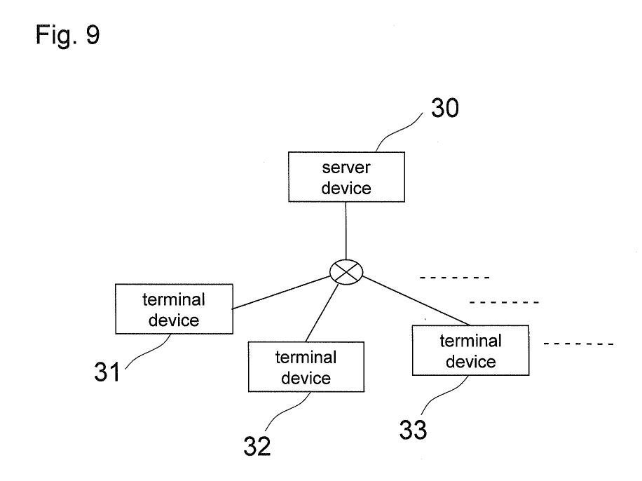

An example of a system according to the server device for designing a primer which is one embodiment of the present invention is shown in FIG. 9. In this example, a server device 30 and terminal devices 31, 32, 33 . . . are connected over the internet. The server device 30 stores the program for designing a primer of the present invention and functions as a web server. The terminal devices 31, 32, 33 . . . store a browser program for browsing websites. The terminal devices 31, 32, 33 . . . are able to design primers by accessing to the server device 30. The terminal devices 31, 32, 33 . . . also have the same hardware configuration as that of the primer designing device of the present invention except for having a receiving unit and a sending unit for communication.

The storage unit of the server device for designing a primer of the present invention is provided with a series of data regions as shown in the above FIG. 5 for each user or for each group to which the user belongs. Each of these regions is identified by user identifier, group identifier or the like.

### <5-1. Process Flowchart>

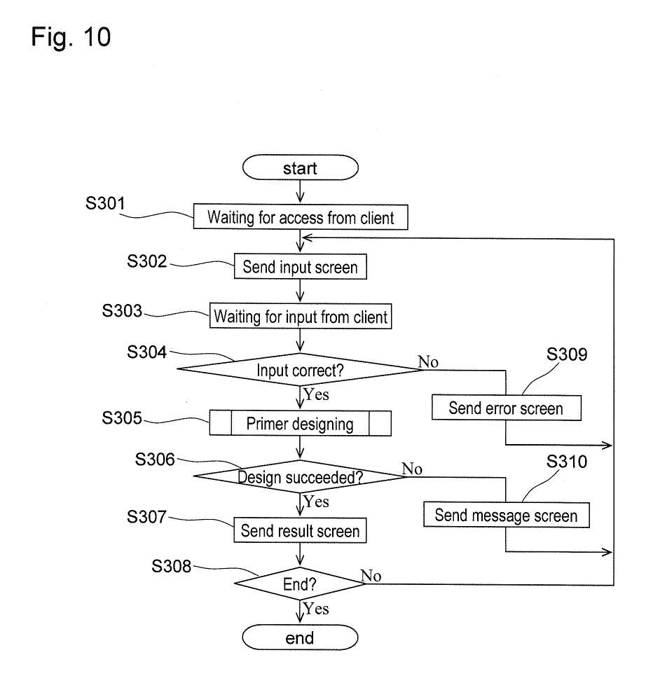

FIG. 10 is a flowchart showing one example of a primer designing method using a primer server designing device of the present invention. In the flowchart, a primer designing process is performed in S305. The process performed in S305 is as shown in FIGS. 7 and 8.

The sever device of the present invention waits until a request for connection to the server is made from a client in S301. In S302, input screen is sent to the client. Here, the case that the server of the present invention has a function of WWW server, and sends HTML format according to TCP/IP is considered as an example. On the end of the client, an input screen is displayed by a web browser, and the following input or the like is made.

In S303, the server device waits for input of information necessary for primer designing made by the client. On the end of the client, input is made, for example, in a most common FASTA format for inputting a base sequence.

In S304, whether the inputted information is correct is determined. When the inputted information is correct (YES), the flow proceeds to S305, whereas when it is incorrect (No), the flow proceeds to S309. In S309, a screen indicating that the input is incorrect is sent to the client.

In S305, based on the inputted information, primer designing is performed. This algorism is as same as that shown in FIGS. 7 and 8.

In S306, whether the primer designing is successfully performed is determined. When the primer design succeeded (YES), the follow proceeds to S307, whereas when the primer design failed (No), the flow proceeds to S310. In S310, the screen indicating that the design failed is sent to the client.

In S307, a result of designing and a screen for displaying the same are sent to the client.

In S308, upon disconnection from the client, the flow proceeds to YES, and the process ends. Not limited to this timing, the process may end by performing end process similarly whenever disconnection is made by the client.

### EXAMPLES

In the following, Examples are given and the present invention will be concretely explained, however, it is to be noted that the present invention is not limited to these Examples. In the following, a “candidate primer” is also simply referred to a “primer”.

In the following Examples, primers for multiplex PCR were designed using the program for designing a primer of the present invention. Using primers that were determined as being most preferred by the program of the present invention, and primers having lower priority order, multiplex PCR was actually conducted. Under the condition that the primers erroneously bind each other, the influence of binding of a PCR product and other primer exerted on efficiency of PCR was verified. Verification was conducted in a multiplex PCR system in which two single nucleotide polymorphism (SNP) sites are amplified. Outline from primer designing to verification is as follows.

<1> For a second SNP site, candidate primers were individually selected by a primer designing software for single PCR.

<2> Complementation between primers were calculated, and a combination of primers where the possibility of erroneous binding is low was selected.

<3> For the combination of primers selected in the above <2>, complementation between a PCR product and a primer was calculated.

<4> Multiplex PCR was conducted using the combination of primers selected in the above <2>.

<5> Amplification amount of PCR product in the above <4> was measured.

<6> Complementation calculation result of the above <3> and measurement result of <5> were compared, to examine whether there is correlation between complementation between a PCR product and a primer, and an amplification amount of PCR product.

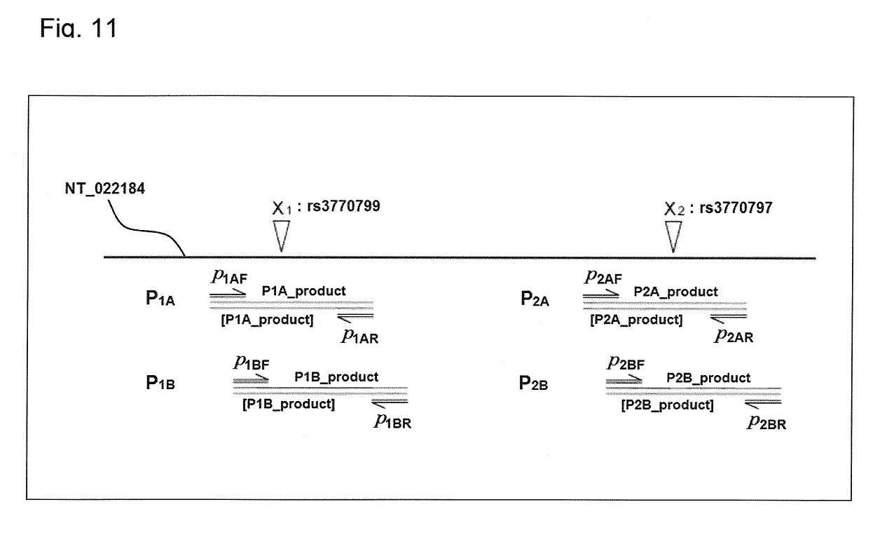

In the following, the procedures of <1> to <6> will be explained in detail with reference to FIG. 11. In the present exemplary example, a command prompt of Windows from Microsoft was used.

<1> Selection of Candidate Primers for Each of Two SNP Sites

From database of SNP, a base sequence “NT_{—}022184” was acquired. Two SNPs contained in this base sequence were selected as amplification targets. “refSNP ID” of these SNPs are “rs3770799” and “rs3770797”, respectively. In the present example, only a base sequence of 20 kbp was picked up from the base sequence “NT_{—}022184”, and inputted to primer designing software. As the primer designing software, primer designing software of single PCR “primer 3” (http://frodo.wi.mit.edu/primer3/primer3_code.html) was used.

(All base sequence of “NT_{—}022184” may also be inputted to the primer designing software. However, in such a case, a lot of time is spent for selecting candidate primers because the size of the base sequence is enormous.)

In this manner, candidate primers for each SNP site were individually selected.

<2> Calculation of Complementation Between Primers

Using software “DPAL” coming with “primer 3” used in primer selection in the above <1>, candidates were selected one for each from the candidate primer group for the amplification targets SNP X₁: “rs3770799” and X₂: “rs2770797”, and a score indicating complementation at 3′-end between primers (local alignment score at 3′-end) was calculated. “DPAL” is software that calculates score of local alignment and global alignment, and allows selection of whether 3′-end is fixed at the time of execution.

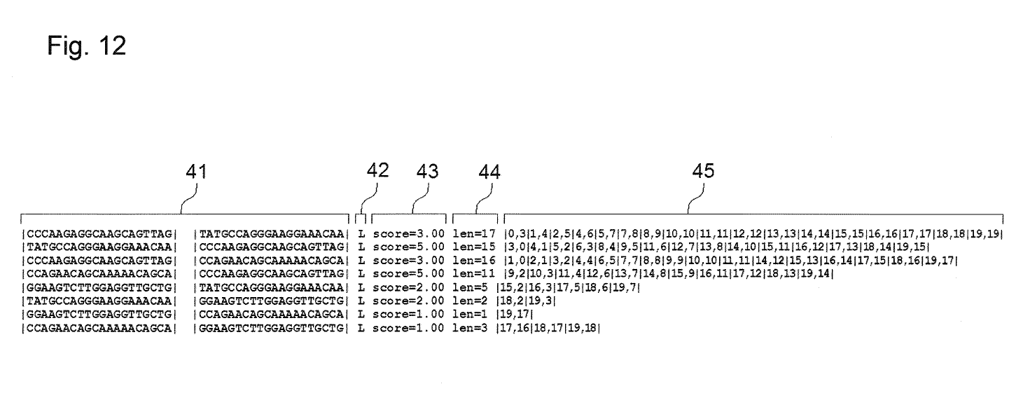

A part of information contained in a file outputted as a result of calculation of complementation between primers is shown in FIG. 12. FIG. 12 shows strings of the part describing calculation results of complementation between primer P_{1A} for X₁ (forward primer “p_{1AF}” & reverse primer “p_{1AR}”) and primer P_{2A} for X₂ (forward primer “p_{2AF}” & reverse primer “p_{2AR}”) in the output file. The information includes two primer sequences 41 for calculating alignment score, information 42 indicative of 3′-end local alignment score, a local alignment score 43, a length of sequence subjected to alignment 44, and information 45 indicating location of base matching between the two sequences.

As a result, the following four combinations of primers were selected. In these combinations, respective primers are selected from the group consisting of primers P_{1A}(“p_{1AF}” & “p_{1AR}”) and P_{1B}(“p_{1BF}” & “p_{1BR}”) for X₁ and primers P_{2A}(“p_{2AF}” & “p_{2AR}”) and P_{2B}(“p_{2BF}” & “p_{2BR}”) for X₂.

### Combination [1] (P_{1A}-P_{2A}):

| | | |
|---|---|---|
| “P1AF”: | CCCAAGAGGCAAGCAGTTAG | (SEQ ID No. 1) |
| “P1AR”: | GGAAGTCTTGGAGGTTGCTG | (SEQ ID No. 2) |
| “P2AF”: | TTGTTTCCTTCCCTGGCATA | (SEQ ID No. 3) |
| “P2AR”: | TGCTGTTTTTGCTGTTCTGG | (SEQ ID No. 4) |

### Combination [2] (P_{1A}-P_{2B}):

| | | |
|---|---|---|
| “p1AF”: | CCCAAGAGGCAAGCAGTTAG | (SEQ ID No. 1) |
| “P1AR”: | GGAAGTCTTGGAGGTTGCTG | (SEQ ID No. 2) |
| “P2BF”: | CCCAATCCTCCCTCCATTTA | (SEQ ID No. 5) |
| “P2BR”: | TGAGCTTTGCAAGGATGTTG | (SEQ ID No. 6) |

### Combination [3] (P_{1B}-P_{2A}):

| | | |
|---|---|---|
| “P1BF”: | TCCTGGAGAGCAGAGTGGAT | (SEQ ID No. 7) |
| “P1BR”: | GGGGTCCCTGGACTACACTT | (SEQ ID No. 8) |
| “P2AF”: | TTGTTTCCTTCCCTGGCATA | (SEQ ID No. 3) |
| “P2AR”: | TGCTGTTTTTGCTGTTCTGG | (SEQ ID No. 4) |

### Combination [4] (P_{1B}-P_{2B}):

| | | |
|---|---|---|
| “P1BF”: | TCCTGGAGAGCAGAGTGGAT | (SEQ ID No. 7) |
| “P1BR”: | GGGGTCCCTGGACTACACTT | (SEQ ID No. 8) |
| “P2BF”: | CCCAATCCTCCCTCCATTTA | (SEQ ID No. 5) |
| “P2BR”: | TGAGCTTTGCAAGGATGTTG | (SEQ ID No. 6) |

<3> Calculation of Complementation Between Amplification Product and Primer

For each combination of primers recited in the above <2>, complementation between an amplification product and a primer was calculated. A sequence of amplification product obtainable when nucleic acid is amplified by using the primers was determined. A sequence of an amplification product may be determined from a sequence of template and positions of primers. Alternatively, it may be determined by using software like e-PCR (http://www.ncbi.nlm.nih.gov/sutils/e-per/). Sequences of amplification products determined by using the software are shown below.

### Amplification Product “P1A_Product” by Primer P_{1A} for X₁:

(SEQ ID No. 9)

CCCAAGAGGCAAGCAGTTAGAAAATGCCACTACTCATCCAGATAAAGCAC
ATAAACCCATGCTCTTTTTAAAATGCTGTTGCTTCCATTTCTTTGCAAGT
TAAATGCAAAAGCAACTGTTTTTATGCTACTATATTCATGCAGGCATTTT
TCTGATGTAGCTAATTGTTCCAATGTAAATGTTGTAAGTTGTACACATAT
TTGTTCTATACAAAATTTACTGTGTAATTTTTAAGATACTTTTTGATATT
ATTTACCTACATTTTATCAGAAGTCTGAAAACTTAAGATGAACAGTATGC
GTATTTTCAGCCTAAGTTTGTATAATTCTACCATCAGTTTGGAGAACATT
AACATAACATTTAGCAAATGAAAATGCTGTTACTTGGAGAGCTGATTATT
GCTTCCCACTCACTCTTCGGGCCACCTGCCACTGCCTTGGTGCAGAAATG
CGAACTAGAAGATGGCATACGCTTCCTGGAGAGCAGAGTGGATCCCATGT
GCCAGCCAGGCCCCCAAAAACTTCTCCAAAGACTTTTCCACTCCGTTTCT
AGGAAACAATTCTACTTTCTTTCTCCCAGCAACCTCCAAGACTTCC

### Amplification Product “P2A_Product” by Primer P_{2A} for X₂:

(SEQ ID No. 10)

TTGTTTCCTTCCCTGGCATAAGTATGTATTGAAAGTCTCAAAATCAGTCC
TTATCTGGAAACTTTTCTCAGACAAAACCAGTAGCAACAATGTATAAACA
GGATATAGATTTATAAAAATTCACCAAAATCTGAAAGACGAAGAAATGGG
CCAAGATCCCCAAGGCCCATTTACAACATCCTTGCAAAGCTCAGAAAACG
AAAATTCAAGCCAAGGATCCTTCCATCCACCTCTAAATAACTCCACATCC
TCATTCCAATGCATGCTGGTTCTGTGAGCTAAGGTCCCTGTTAAGCTTTT
GTTTACTCATTTATGAAATGGAAATAATAACAATAATACCTTCTTTATAG
AGTTGTTGTGAAGGTTACATGGAATAATCCATGCAAGTACCTAGCAAAGT
GCTCAGCAAATATCAATATTCAAAAAAGTATTGGCTATAATTCCTAAAAA
TAAAAAGGATAGAATAATATTTTAGACACAACTCCCAAAGAGAAATAACC
ACACCTTTCTACTTTTCTCCAGAACAGCAAAAACAGCA

### Amplification Product “P1B_Product” by Primer P_{1B} for X₁:

(SEQ ID No. 11)

TCCTGGAGAGCAGAGTGGATCCCATGTGCCAGCCAGGCCCCCAAAAACTT
CTCCAAAGACTTTTCCACTCCGTTTCTAGGAAACAATTCTACTTTCTTTC
TCCCAGCAACCTCCAAGACTTCCTAGAATTCTTTGTACTGAAAAGGGAGT
ATTTTTTTCCTAAACAACTTATCTTGATTTGTAACCAGTCTACAATGTCA
TCAAGCATAGTAAAAAGCGTCTGGTGGCACCTCTATGGCGGCTGAGTCAA
AGGAGTGAGATGGATTCTTACAGCATGACTAATTAAGGGGAAAGGCTTCG
TGAAAAGGAAGTGAAGGCCTGACTCACITGATGGTTCCTTCCCCTGGAAT
TTTATAGAGGAAATTTAAATCAGTAAACACATTTGAGGAGTCAACATAAA
GAATATTTTACCAGGCCCCAAGGGGCAGAAGAAAGGAAACCAAGGGAATG
GTCATCAAGAAATACATATAGTTTCATCCAGTGGTTCTCAAAGTGTAGTC
CAGGGACCCC

### Amplification Product “P2B_Product” by Primer P_{2B} for X₂:

(SEQ ID No. 12)

CCCAATCCTCCCTCCATTTAATCTACCATTTCCAAGTTTGAAATAAAGAA
TCCAAGTGTTCAAATTCAAAGTGAAGAACTGGTGAAAATTCTGAATCTGA
AGTTATTTTGTAATTGATTCATCCATTTCCCACTACGTCTTTAGGAAGGA
GTTAATAGTGCTATAAAATGCCCCCTCTCAGGATGGAATTTTTGATAGGA
GCCCATTTGTGAGCAGGGAAATGATTAAGCATTACAGTATTTACTTTATT
GTTGCCCTCACTACTGACAAATGCCAAAGTAATGTGGCAAGGACGGAGGA
AGAGGGTATTCAATACACAGCTTCAACACCAGTATTTACGCTGAGAATAC
TCACCACTGCCTCGTGGTTGTTTCCTTCCCTGGCATAAGTATGTATTGAA
AGTCTCAAAATCAGTCCTTATCTGGAAACTTTTCTCAGACAAAACCAGTA
GCAACAATGTATAAACAGGATATAGATTTATAAAAATTCACCAAAATCTG
AAAGACGAAGAAATGGGCCAAGATCCCCAAGGCCCATTTACAACATCCTT
GCAAAGCTCA

Next, in the same manner as described in <2>, each one sequence was selected from primers and amplification products respectively, and 3′-end fixed local alignment score between a primer and an amplification product was determined. Here, only a score when 3′-end of primer is fixed needs to be known, and it is not necessary to determine a score when 3′-end of the amplification product is fixed.

Combinations between a primer and an amplification product for which calculation of complementation was performed are as follows:

### Combination [5] (P_{1A}-P2A_product)

### Combination [6] (P_{1A}-P2B_product)

### Combination [7] (P_{1B}-P2A_product)

### Combination [8] (P_{1B}-P2B_product)

### Combination [9] (P_{2A}-P1A_product)

### Combination [10] (P_{2B}-P1A_product)

### Combination [11] (P_{2A}-P1B_product)

### Combination [12] (P_{2B}-P1B_product)

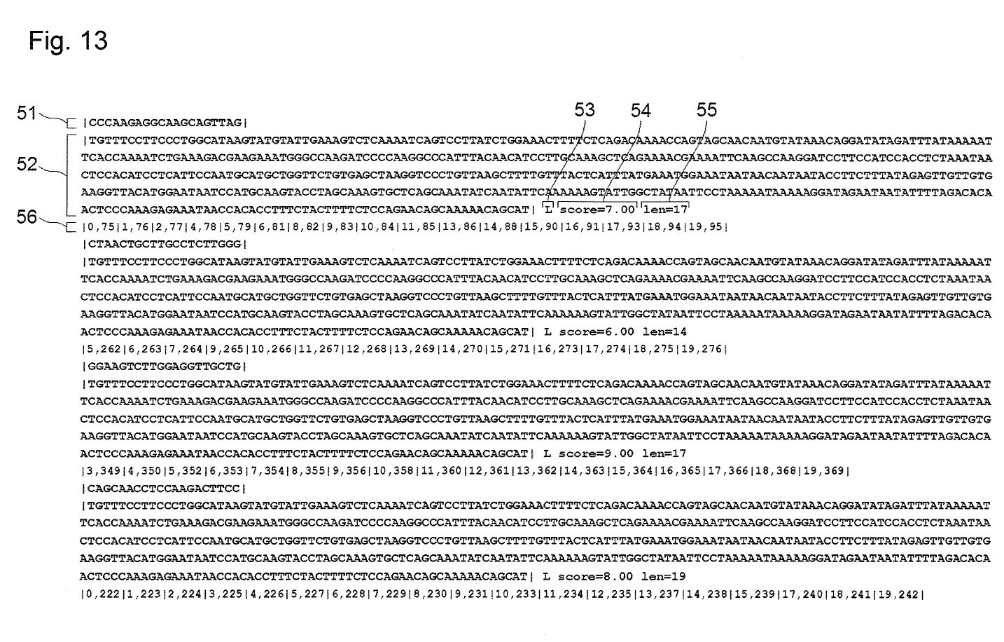

FIG. 13 shows part of information contained in a file outputted as a result of calculation of complementation between a primer and an amplification product. FIG. 13 shows strings of the part describing a calculation result of complementation by combination [5] (P_{1A}-P2A_product) in the output file. The information includes a primer sequence 51 and an amplification product 52 for calculating alignment score, information 53 indicative of 3′-end local alignment score, a local alignment score 54, a length of sequence subjected to alignment 55, and information 56 indicating location of base matching between two sequences.

Further, required data is extracted from calculation results about complementation between primers (of combinations [1] to [4]) obtained in <2>, and about complementation between a primer and an amplification product (of combinations [5] to [12]) obtained in <3>, and summarized in Tables 1, 2 and 3 below.

Table 1 below shows a total of local alignment score (total score), a total of length of sequence subjected to alignment (total length) and ratio thereof (ratio: total score/total length×100) in calculation results of complementation between primers (of combinations [1] to [4]) obtained in <2>.

TABLE 1
primer - primer

| | total score | total length | ratio |
|---|---|---|---|
| [1] P_{1A}-P_{2A} | 22 | 70 | 31.4 |
| [2] P_{1A}-P_{2B} | 33 | 74 | 44.6 |
| [3] P_{1B}-P_{2A} | 20 | 66 | 30.3 |
| [4] P_{1B}-P_{2B} | 34 | 68 | 50 |

Table 2 below shows a total of local alignment score (total score), a total of length of sequence subjected to alignment (total length) and ratio thereof (ratio: total score/total length×100) in calculation results of complementation between a primer and an amplification product (of combinations [5] to [8]) obtained in <3>. It is noted that combinations [5] to [8] are combinations of primer and amplification product which are present in a reaction system for obtaining amplification products containing X₂ as an amplification product.

TABLE 2
primer - PCR product

| | total score | total length | ratio |
|---|---|---|---|
| [5] P_{1A} with P2A product | 30 | 67 | 44.8 |
| [6] P_{1A} with P2B product | 29 | 64 | 45.3 |
| [7] P_{1B} with P2A product | 32 | 63 | 50.8 |
| [8] P_{1B} with P2B product | 33 | 60 | 55 |

Table 3 below shows a total of a local alignment score (total score), a total of length of sequence subjected to alignment (total length) and ratio thereof (ratio: total score/total length×100) in calculation results of complementation between a primer and an amplification product (of combinations [9] to [12]) obtained in <3>. It is noted that combinations [9] to [12] are combinations of primer and amplification product which are present in a reaction system for obtaining amplification products containing X₁ as an amplification product.

TABLE 3
primer - PCR product

| | total | | |
|---|---|---|---|
| | score | total length | ratio |
| [9] P_{2A} with P1A product | 38 | 58 | 65.5 |
| [10] P_{2B} with P1A product | 31 | 63 | 49.2 |
| [11] P_{2A} with P1B product | 35 | 56 | 62.5 |
| [12] P_{2B} with P1B product | 31 | 65 | 47.7 |

Herein, as already described, since the “score” is a score of local alignment, and the “length” is a length of sequence subjected to the alignment, the longer length and the smaller score represent the lowness of the complementation. Therefore, the smaller the value of the ratio represented by a ratio of the score with respect to the length, the lower the complementation between two subject sequence is meant. This in turn means preferable condition for the primers. This was demonstrated in the <4> below.

<4> Verification of Amplification Amount by Using Selected Primers

Multiplex PCR was conducted in four different ways respectively using primers of four combinations [1] to [4] selected in the above <2>. Multiplex PCR was conducted in 30 cycles.

An amplification amount of the PCR product was measured by utilizing an invader reaction. Through multiplex PCR, amplification products containing X₁: “rs3770799” and amplification products containing X₂: “rs2770797” can be obtained. Since these SNPs (X₁ and X₂) are individually detected by an invader reaction, respective amounts of these amplification products can be examined.

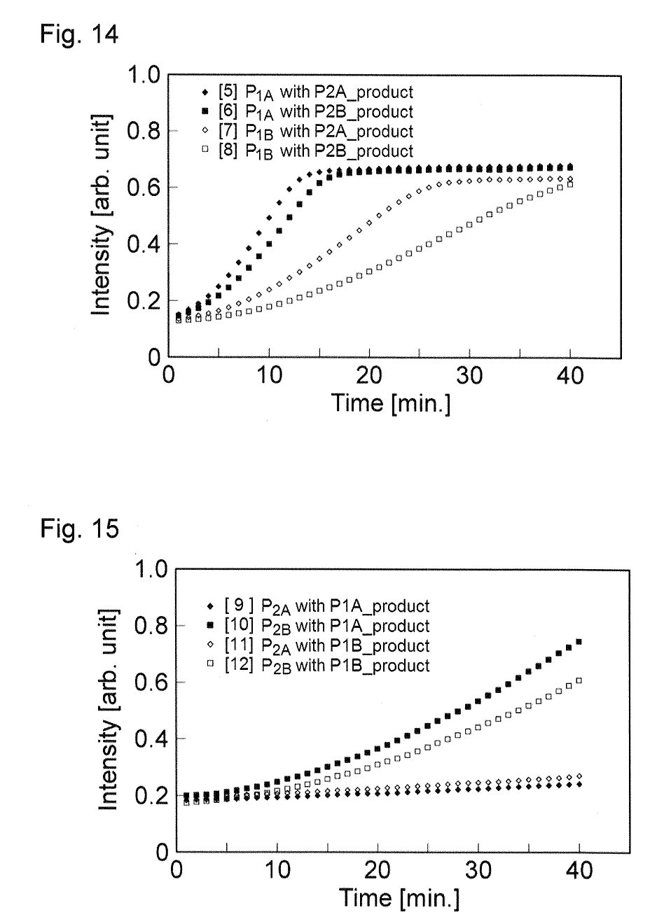

In an invader reaction, simultaneous measurement of amounts of two PCR products was enabled by using two probes corresponding to two PCR products to be measured, and added with fluorescent substances having different wavelengths. As the invader reaction proceeds, fluorescent intensity in each PCR product increases, and the rate of increase changes with the amplification amount of the PCR product. That is, when the amplification amount is large, the increasing rate of fluorescent intensity is large, while on the other hand, when the amplification amount is small, the increasing rate of fluorescent intensity is small. Results of PCR product amounts measured in this manner are shown in graphs of FIG. 14 and FIG. 15. From each curve, an amount of the amplification product obtained by the reaction system containing the combination of the primer and the amplification product shown in the drawing can be known.

Furthermore, inclination of amplification curve in these graphs was calculated by least-squares analysis. The calculation result is shown in Tables 4(a) and 4(b) below.

In Table 4(a), as to the reaction system for obtaining amplification products containing SNP X₂, inclination of the amplification curve is shown together with the used combination of primers, complementation index between these primers (that is, ratio value obtained in Table 1), combination of primer and amplification product that are present in the reaction system, complementary score between the primer and the amplification product (that is, ratio value obtained in the above Table 2) and so on.

In Table 4(b), as to the reaction system for obtaining amplification products containing SNP X₁, inclination of the amplification curve is shown together with used combination of primers, complementation index between these primers (that is, ratio value obtained in Table 1), combination of primer and amplification product that are present in the reaction system, complementary score between the primer and the amplification product (that is, ratio value obtained in the above Table 3) and so on.

TABLE 4(a)

| | | | | | complementary | |
|---|---|---|---|---|---|---|
| | | | SNP | combination of primer | score between the | inclination |
| | complementation | | detected | and amplification | primer and the | of the |
| combination of | index between | amplification | by invader | product that are present | amplification | amplification |
| primers | primers (ratio) | product | method | in the reaction system | product (ratio) | curve |
| [1] P_{1A}-P_{2A} | 31.4 | P2A_product | X₂ | [5] P_{1A}-P2A_product | 44.8 | 0.0422 |
| [2] P_{1A}-P_{2B} | 44.6 | P2B_product | X₂ | [6] P_{1A}-P2B_product | 45.3 | 0.0353 |
| [3] P_{1B}-P_{2A} | 30.3 | P2A_product | X₂ | [7] P_{1B}-P2A_product | 50.8 | 0.0218 |
| [4] P_{1B}-P_{2B} | 50 | P2B_product | X₂ | [8] P_{1B}-P2B_product | 55 | 0.0154 |

TABLE 4(b)

| | | | | | complementary | |
|---|---|---|---|---|---|---|
| | | | SNP | combination of primer | score between the | inclination |
| | complementation | | detected | and amplification | primer and the | of the |
| combination of | index between | amplification | by invader | product that are present | amplification | amplification |
| primers | primers (ratio) | product | method | in the reaction system | product (ratio) | curve |
| [1] P_{1A}-P_{2A} | 31.4 | P1A_product | X₁ | [9] P_{2A}-P1A_product | 65.5 | 0.0015 |
| [2] P_{1A}-P_{2B} | 44.6 | P1A_product | X₁ | [10] P_{2B}-P1A_product | 49.2 | 0.0166 |
| [3] P_{1B}-P_{2A} | 30.3 | P1B_product | X₁ | [11] P_{2A}-P1B_product | 62.5 | 0.0019 |
| [4] P_{1B}-P_{2B} | 50 | P1B_product | X₁ | [12] P_{2B}-P1B_product | 47.7 | 0.0138 |

As can be seen from Tables 4(a) and 4(b), respectively, inclination of amplification curve is not correlated with a complementation index between primers, but is well correlated with a complementation index between a primer and an amplification product. This suggests that amplification amount can be evaluated by determining complementation index between a primer and an amplification product (ratio value).

From the above, it can be evaluated that primers of the combination [2] (that is, P_{1A}-P_{2B}) wherein complementation index between primers and complementation index between a primer and an amplification product are generally good synthesize both the amplification products containing SNP X₁ and amplification products containing SNP X₂ efficiently and hence are optimum primers.

As described above, it was proved that efficient synthesis of plural amplification targets greatly relies on further conducting determination of complementation between a primer and an amplification product, rather than merely determining complementation between primers as is conventionally made.

In the above example, concrete forms within the scope of the present invention have been shown, however, the present invention may be practiced in various forms without limited to the above concrete forms. Accordingly, the above example is merely illustrative in every point and should not be interpreted as limitative. Further, any modifications made within the equivalents of claims fall within the scope of the present invention.

1. A device for designing a series of primers for amplifying a plurality of sites in nucleic acid, comprising:
(I) an input unit for inputting a processing command including a calculation command A for calculating complementation between a candidate primer and an amplification product;
(II) a processing unit for performing process, upon reception of the calculation command A, including calculating and scoring complementation, for every combination selecting two sites from a plurality of sites to be amplified, between a sequence of the candidate primer for one of the two sites, and a sequence of the amplification product obtainable in the other of the two sites, thereby
determining a series of primers for amplifying the plurality of sites;
(III) a storage unit for storing at least:
data of candidate primer groups respectively made up of a plurality of the candidate primers and corresponding to each of the plurality of sites to be amplified,
data of an amplification product group made up of a plurality of the amplification products, each of the plural amplification products being obtainable by amplification reaction using the candidate primer in each of the site to be amplified,
a result of the complementation calculated by the processing unit, and
the series of primers determined by the processing unit; and
(IV) an output unit for outputting the series of primers determined by the processing unit.

2. The primer designing device according to claim 1, wherein
the processing command inputted in the input unit (I) further includes a selection command B for selecting the candidate primer group,
the process executed in the processing unit (II) further includes, upon reception of the selection command B, selecting the candidate primer group based on at least a sequence of nucleic acid to be amplified, information of sites to be amplified in the nucleic acid, and primer designing parameters, and
the storage unit (III) further stores at least the sequence of nucleic acid to be amplified, the information of sites to be amplified in the nucleic acid, and the primer designing parameters.

3. The primer designing device according to claim 2, wherein the primer designing parameters include melting temperature, GC content, base length, amplification product length, specificity of a base sequence to target site, and intermolecular complementation between primer molecules of a primer pair for one site, or intramolecular complementation of a primer molecule.

4. The primer designing device according to claim 1, wherein
the processing command inputted in the input unit (I) further includes a calculation command C for calculating the amplification product,
the process executed in the processing unit (II) further includes, upon reception of the calculation command C, calculating an amplification product obtainable by amplification reaction in each of the plural sites to be amplified based on at least a sequence of nucleic acid to be amplified and a sequence of the candidate primer, and
the storage unit (III) further stores at least a sequence of nucleic acid to be amplified.

5. The primer designing device according to claim 1, wherein
the processing command inputted in the input unit (I) further includes a calculation command D for calculating complementation between the candidate primers, and
the process executed in the processing unit (II) further includes, upon reception of the calculation command D, calculating complementation, in the case two sites are arbitrarily selected from the plural sites to be amplified, between a sequence of candidate primer for one of the two sites and a sequence of candidate primer for the other of the two sites.

6. A primer designing program for making a computer execute a process for determining a series of primers for amplifying a plurality of sequences in nucleic acid, wherein the computer is made to execute:
by provision of at least data of candidate primer groups respectively made up of a plurality of candidate primers and corresponding to each of plurality of sites to be amplified, and data of an amplification product group made up of a plurality of amplification products, each of the plural amplification products being obtainable by amplification reaction using the candidate primer in each of the site to be amplified,
upon reception of a calculation command A for calculating complementation between the candidate primer and the amplification product,
performing the step including execution of calculating and scoring complementation, for every combination selecting two sites from the plurality of sites to be amplified, between a sequence of the candidate primer for one of the two sites, and a sequence of the amplification product obtainable in the other of the two sites, thereby
performing a process for determining a series of primers for amplifying the plurality of sites from the plurality of the candidate primer groups.

7. The primer designing program according to claim 6, further comprising performing, upon reception of a selection command B for selecting the candidate primer group, the step including execution of selecting the candidate primer group based on at least a sequence of nucleic acid to be amplified, information of sites to be amplified in the nucleic acid, and primer designing parameters.

8. The primer designing program according to claim 7, wherein the primer designing parameters include melting temperature, GC content, base length, amplification product length, specificity of a base sequence to target site, and intermolecular complementation between primer molecules of a primer pair for one site, or intramolecular complementation of a primer molecule.

9. The primer designing program according to claim 6, further performing, upon reception of a calculation command C for calculating the amplification product, a step including execution of calculating an amplification product obtainable by amplification reaction in each of the plural sites to be amplified based on at least a sequence of nucleic acid to be amplified and a sequence of the candidate primer.

10. The primer designing program according to claim 6, further performing, upon reception of a calculation command D for calculating complementation between the candidate primers, a step including execution of calculating complementation, in the case two sites are arbitrarily selected from the plural sites to be amplified, between a sequence of candidate primer for one of the two sites and a sequence of candidate primer for the other of the two sites.

11. A server device for designing a series of primers for amplifying a plurality of sites in nucleic acid, capable of communicating with other computer over network, comprising:
(V) a receiving unit for receiving a processing command including a calculation command A for calculating complementation between a candidate primer and an amplification product, sent from other computer;
(VI) a processing unit for performing process, upon reception of the calculation command A, including calculating and scoring complementation, for every combination selecting two sites from a plurality of sites to be amplified, between a sequence of the candidate primer for one of the two sites, and a sequence of the amplification product obtainable in the other of the two sites, thereby
determining a series of primers for amplifying the plurality of sites from the plurality of the candidate primer groups;
(VII) a storage unit for storing:
data of candidate primer groups respectively made up of a plurality of the candidate primers and corresponding to each of the plurality of sites to be amplified,
data of an amplification product group made up of a plurality of the amplification products, each of the plural amplification products being obtainable by amplification reaction using the candidate primer in each of the site to be amplified,
a result of the complementation calculated by the processing unit, and
the series of primers determined by the processing unit; and
(VIII) a sending unit for sending the series of primers determined by the processing unit to other computer.

12. The server device for designing a primer according to claim 11, wherein
the processing command received in the receiving unit (V) further includes a selection command B for selecting the candidate primer group,
the process executed in the processing unit (VI) further includes, upon reception of the selection command B, selecting the candidate primer group based on at least a sequence of nucleic acid to be amplified, information of sites to be amplified in the nucleic acid, and primer designing parameters, and
the storage unit (VII) further stores at least the sequence of nucleic acid to be amplified, the information of sites to be amplified in the nucleic acid, and the primer designing parameters.

13. The server device for designing a primer according to claim 12, wherein the primer designing parameters include melting temperature, GC content, base length, amplification product length, specificity of a base sequence to target site, and intermolecular complementation between primer molecules of a primer pair for one site, or intramolecular complementation of a primer molecule.

14. The server device for designing a primer according to claim 11, wherein
the processing command received in the receiving unit (V) further includes a calculation command C for calculating the amplification product,
the process executed in the processing unit (VI) further includes, upon reception of the calculation command C, calculating an amplification product obtainable by amplification reaction in each of the plural sites to be amplified based on at least a sequence of nucleic acid to be amplified and a sequence of the candidate primer, and
the storage unit (VII) further stores at least a sequence of nucleic acid to be amplified.

15. The server device for designing a primer according to claim 11, wherein
the processing command received in the receiving unit (V) further includes a calculation command D for calculating complementation between candidate primers, and
the process executed in the processing unit (VI) further includes, upon reception of the calculation command D, calculating complementation, in the case two sites are arbitrarily selected from the plural sites to be amplified, between a sequence of candidate primer for one of the two sites and a sequence of candidate primer for the other of the two sites.
